(19) United States
(12) Patent Application Publication
(10) Pub. No.: US 2010/0119085 A1
(43) Pub. Date: May 13, 2010

(54) Audio Signal Processing System

(75) Inventors: Masahiro SHIMIZU, Hamamatsu-shi (JP); Kei NAKAYAMA, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-shi (JP)

(21) Appl. No.: 12/615,591

(22) Filed: Nov. 10, 2009

(30) Foreign Application Priority Data
Nov. 10, 2008 (JP) 2008-288122

(51) Int. Cl. H04B 1/00

(52) U.S. Cl. 381/119

(57) ABSTRACT

In an audio network system performing real-time transport of audio signals among a series of sequentially connected devices by circulating a TL frame including a plurality of storage regions for the audio signals in a fixed period along a ring transmission route formed among the devices and writing and/or reading the audio signals from/to the TL frame in each of the devices, a mixer of an active system reflecting its processing result in the output and a mixer of a standby system for backup are prepared, so that the mixers perform the same signal processing on waveform data read from the same position of the TL frame and when a switching instruction is issued, the mixer of the standby system reflects its processing result in the output instead of the active system.

### BACKGROUND OF THE INVENTION

1. Field of the Invention

The invention relates to an audio signal processing system having a function of transporting audio signals on real time among a plurality of processors.

2. Description of the Related Art

There is a conventionally known mixer system configured such that a plurality of mixer engines perform the same operation in parallel, and the result of mixing by one of the mixer engines is used as the output under normal condition, whereas when an abnormality has occurred in the mixer engine in use, the result of mixing by the other mixer engine is used as the output.

With such a mixer system, even if one of the prepared mixer engines breaks down, the other mixer engine can be used as a backup, thereby realizing a so-called fault-tolerant system.

Such a mixer system is described, for example, in the following Document 1.

### Document 1: Japanese Patent Laid-open Publication No. 2003-101442

Further, it has also been known, in the case of operating WWW (World Wide Web) server, online system, router and so on, that fault-tolerant systems are constructed by a method of preparing a processor performing process when the system has no trouble and a processor performing backup therefor and, if a trouble has occurred in the processor in use, causing the backup processor to continue the operation.

Further, in addition to the above techniques, an audio network system has been conventionally known for transporting audio signals between a plurality of nodes, and is used in concerts, dramas, music production, private broadcasting, and so on. Known examples of such an audio network system include CobraNet (trademark), and EtherSound (trademark) as described in the following Documents 2 and 3.

Document 2: “CobraNet™”, [online], Balcom Co. [Retrieved on Mar. 21, 2006] Internet<URL:http://www.balcom.co.jp/cobranet.htm>
Document 3: Carl Conrad, “EtherSound™ in a studio environment”, [online], Digigram S.A., [Retrieved on Mar. 21, 2006] Internet<URL: http://www.ethersound.com/news/getnews.php?enews_key=101>

### SUMMARY OF THE INVENTION

However, if employing the technique described in the Document 1 to realize the fault-tolerant system, it is necessary to connect cables to two mixer engines separately from each of the input unit and the output unit. In other words, the required labor of wiring for the two mixer engines is twice that in the case where the signal processing is performed using one mixer engine which is minimally required for the signal processing.

On the other hand, when the audio network system performing transport of audio signals among many nodes is constructed as described in the Document 2 and 3, there is no known method of effectively constructing the fault-tolerant system. This is because even if the method used in the ordinary network systems such as WWW server, online system, router is applied to the audio network system, such a conventional method requires a lot of time for the process causing the backup processor to continue the operation of the processor in which a failure has occurred, during which signal transport is interrupted for several seconds to several tens of seconds.

However, the system in which the signal transport is interrupted for such a long time cannot be said to have a sufficient performance in terms of usage of the audio signal transport. This is because if a failure has occurred in the operation of the processor in use when the system is used in concerts and the like, it is required for the backup processor to continue the operation in a time to an extent that is hardly sensed by human ears.

An object of the invention is to solve the above-described problems and enable to easily construct a function of continuing signal processing as before even when abnormality occurs in part of processors in an audio signal processing system transporting audio signals among a plurality of processors and performing signal processing.

To attain the above objects, an audio signal processing system of the invention is an audio signal processing system wherein a plurality of devices respectively including two sets of receivers and transmitters each performing communication in a single direction are connected in series by connecting one set of the receiver and transmitter in one device to one set of the transmitter and receiver in a next device by communication cables, respectively, an audio transport frame including a plurality of storage regions for audio signals circulates along a ring transmission route formed among the plurality of devices at a constant period, and each of the devices writes audio signals to the audio transport frame and/or reads audio signals from the audio transport frame, to thereby transport the audio signals among the plurality of devices, a device among the plurality of devices is a first signal processing engine that reads audio signals from a first storage region of the audio transport frame, performs signal processing on the read audio signals according to control signals received from a console, and writes the processed audio signals into a second storage region of the audio transport frame, another device among the plurality of devices is a second signal processing engine that corresponds to the first signal processing engine, reads audio signals from the first storage region of the audio transport frame, and performs signal processing on the read audio signals according to control signals received from the console, the signal processing being the same as that the corresponding first signal processing engine performs, a device among the plurality of devices is an input device that writes audio signals inputted from an external of the audio signal processing system into the audio transport frame, a device among the plurality of devices is an output device that is integrated with or separated from the input device, reads audio signals from the audio transport frame, and outputs the read audio signal to an external of the audio signal processing system.

Further, in the audio signal processing system of the invention, the first signal processing engine and the second signal processing engine are placed at two consecutive positions in the ring transmission route, and in response to a switching instruction, the first signal processing engine and/or second signal processing engine switches its operation such that the audio signal processed in the second signal processing engine is written into the second storage region of the audio transport frame and reaches the output device, while the audio signal processed in the first signal processing engine is written into the second storage region of the audio transport frame and reaches the output device before the switching.

Alternatively, in another audio signal processing system of the invention the second signal processing engine is placed at a position just before the first signal processing engine in the ring transmission route, and in response to a switching instruction, the second signal processing engine starts writing the processed audio data into the second storage region of the audio transport frame from a next audio transport frame after transmission of an audio transport frame in transmission at detection of the switching instruction is finished.

Still another audio signal processing system of the invention is an audio signal processing system including: a network system wherein a plurality of devices respectively including two sets of receivers and transmitters each performing communication in a single direction are connected in series by connecting one set of the receiver and transmitter in one device to one set of the transmitter and receiver in a next device by communication cables, respectively; and a console that is connected to a device among the plurality of devices and generates control signals to control devices constituting the network system, wherein the network system circulates an audio transport frame including a plurality of storage regions for audio signals along a ring transmission route formed among the plurality of devices at a constant period, each of the devices writes audio signals to the audio transport frame and/or reads audio signals from the audio transport frame, to thereby transport the audio signals among the plurality of devices, and the network system is capable of transporting the control signals generated by the console to a target device among the plurality of devices, a device among the plurality of devices is a first signal processing engine that reads audio signals from a first storage region of the audio transport frame, performs signal processing on the read audio signals according to the control signals, and writes the processed audio signals into a second storage region of the audio transport frame, another device among the plurality of devices is a second signal processing engine that corresponds to the first signal processing engine, reads audio signals from the first storage region of the audio transport frame, performs signal processing on the read audio signals according to the control signals, the signal processing being the same as that the corresponding first signal processing engine performs, and writes the processed audio signals into the second storage region of the audio transport frame, the second signal processing engine in placed at a position just after the first signal processing engine in the ring transmission route, a device among the plurality of devices is an input device that writes audio signals inputted from an external of the audio signal processing system into the audio transport frame, a device among the plurality of devices is an output device that is integrated with or separated from the input device, reads audio signals from the audio transport frame, and outputs the read audio signal to an external of the audio signal processing system, and in response to a switching instruction, the first signal processing engine stops writing audio data into the second storage region of the audio transport frame from a next audio transport frame after transmission of an audio transport frame in transmission at detection of the switching instruction is finished.

In the above audio signal processing systems, it is preferable that the first signal processing engine includes: a CPU that controls operation of the first signal processing engine; and a timer, the CPU periodically resets the timer, and the timer automatically generates the switching instruction if the timer has not been cleared for a period.

It is also preferable that the console generates the switching instruction in response to an operation by a user, and sends the generated switching instruction to at least an audio signal processing engine which is disposed downstream of another in the transmission route among the first audio signal processing engine and the corresponding second signal processing engine.

It is also preferable that the first signal processing engine includes: a checker that checks operation of the first audio signal processing engine; and a notifier that, when the checker detects abnormality in the operation of the first audio signal processing engine, notifies the console of the detection of the abnormality.

In this case, it is further preferable that the first signal processing engine further includes a generator that automatically generates the switching instruction when the checker continues to detect the abnormality for a period.

Alternatively, in the above audio signal processing systems, it is preferable that an upstream engine which is disposed upstream of another down stream engine in the transmission route among the first audio signal processing engine and the corresponding second signal processing engine writes the audio signals having processed in the upstream engine into the second storage region of the audio transport frame, and the downstream engine reads the audio signals written by the upstream engine from the second storage region of the audio transport frame, and compares the read audio signals with the audio signals having processed in the downstream engine, whereby searching inconsistency between the signal processing performed in the upstream engine and that in the downstream engine.

The above and other objects, features and advantages of the invention will be apparent from the following detailed description which is to be read in conjunction with the accompanying drawings.

### BRIEF DESCRIPTION OF THE DRAWINGS

FIG. 1A to FIG. 1C are diagrams showing outline of an audio network system that is an embodiment of an audio signal processing system of the invention;

FIG. 2 is an illustration showing a configuration example of the TL frame transported through transmission routes shown in FIG. 1A to FIG. 1C;

FIG. 3 is a chart showing a transport timing of the TL frame shown in FIG. 2;

FIG. 4 is an illustration showing transport states of the TL frame shown in FIG. 2 in a single mode audio signal transportation on the audio network system;

FIG. 5 is a diagram showing hardware configuration of an audio signal processor which is to be each of the nodes constituting the audio network system;

FIG. 6 is a diagram showing configuration of the waveform transport I/O unit shown in FIG. 5;

FIGS. 7A and 7B are diagrams showing more concrete configuration examples of the audio network system shown in FIGS. 1A to 1C;

FIG. 8 is a chart showing outline of reading/writing of the waveform data from/to the TL frame performed by each of the nodes shown in FIGS. 7A and 7B;

FIG. 9 is an illustration for explaining setting of write or not by the upstream mixer B and the downstream mixer C according to the situation in the system shown in FIGS. 7A and 7B;

FIG. 10 is a flowchart of operation confirming process executed by the CPU of each of the mixers constituting the system shown in FIGS. 7A and 7B;

FIG. 11 is a flowchart of process of switching write or not executed by the CPU;

FIG. 12 is a chart showing operations relating to the function of switching between the active system and the standby system executed by the controller of the waveform transport I/O unit in response to various events in the mixers constituting the system shown in FIGS. 7A and 7B;

FIG. 13 is a flowchart of process executed by the CPU when the CPU receives notification of an event from the waveform transport I/O unit in the mixer constituting the system shown in FIGS. 7A and 7B;

FIG. 14 shows message examples to be displayed on the display device by the console according to the notifications from the CPU of the mixer in the system shown in FIGS. 7A and 7B;

FIGS. 15A and 15B are diagrams for explaining the operations when a break of wire has occurred between the nodes in the audio network system shown in FIGS. 7A and 7B; and

FIG. 16 is an illustration showing configuration of a modification of the embodiment of the invention.

### DETAILED DESCRIPTION OF THE PREFERRED EMBODIMENTS

Hereinafter, preferred embodiments to embody the invention will be concretely described based on the drawings.

### 1. Outline of Audio Network System of Embodiment of the Invention

### 1.1 Entire Configuration

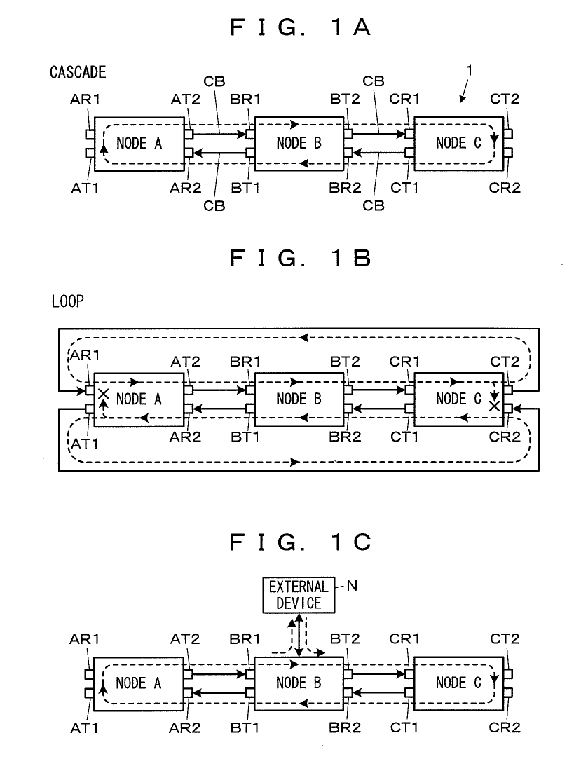

FIG. 1A to FIG. 1C show outline of an audio network system that is an embodiment of an audio signal processing system of the invention.

As shown in FIG. 1A and FIG. 1B, the audio network system 1 is constructed by connecting nodes A to C by communication cables CB in sequence, each of the nodes A to C including two sets of reception interfaces (I/Fs) being receivers and transmission I/Fs being transmitters each of which performs communication in a single direction. Although an example composed of three nodes is shown, any number of nodes may be employed.

In the node A, a reception I/F AR1 and a transmission I/F AT1 are one set of I/Fs, and a reception I/F AR2 and a transmission I/F AT2 are another set of I/Fs. For the nodes B and C, the same relation also applies to I/Fs with a first character of symbol “B” or “C” in place of “A.”

The connection between the nodes is established by connecting one set of reception I/F and transmission I/F to one set of transmission I/F and reception I/F of another node via the communication cables CB, respectively. For example, between the node A and the node B, the reception I/F AR2 is connected with the transmission I/F BT1, and the transmission I/F AT2 is connected with the reception I/F BR1. Further, between the node B and the node C, another set of I/Fs in the node B are connected with one set of I/Fs in the node C.

Note that each of the nodes shown in FIG. 1A to FIG. 1C is an input device inputting analog or digital audio signals supplied from the external of the system into the system, an output device outputting audio signals processed in the system to the external of the system, a signal processing engine performing signal processing such as mixing, effect addition, and the like on the audio signals inputted into the system, or the like. It is of course adoptable that each node has different functions.

The state in which the nodes are connected as one line having ends as shown in FIG. 1A shall be called “cascade.” In this case, the cables CB connecting between the nodes can be used to form one ring data transmission route as shown by a broken line. Further, each node can perform transmission/reception of various kinds of data including audio waveform data (hereinafter, referred to simply as “waveform data”) being audio signals to/from any node on the route by transporting an frame over the route in a manner to circulate it in a constant period and reading/writing necessary information from/into the frame.

In the audio network system 1, one node becomes a master node, which generates the frame for transporting audio signals, periodically circulates it over the transmission route, and manages the network. The frame for transporting audio signals generated by the master node shall be called a “TL (Transporting Lorry) frame” distinguished from other frames.

Connecting I/Fs which are not used in the nodes at both ends by using communication cables CB in addition to the cascade shown at FIG. 1A, two ring data transmission routes can be formed as shown in FIG. 1B. Each of the nodes can perform transmission/reception of data to/from any node on the routes by transporting TL frames over the routes respectively and reading/writing necessary information from/into the TL frames. The connection status among the nodes shall be called a “loop connection.”

Note that although two cables are shown in FIG. 1A to FIG. 1C, one cable which is made by bundling the two cables together can also be used to establish connection between one set of I/Fs, as long as the reception I/F and transmission I/F in one set are adjacently or integrally provided.

Further, when each node is provided with a necessary I/F, an external device N can be connected thereto as shown in FIG. 1C so that the node can write data received from the external device N into the TL frame and transmit the TL frame to another node and to transmit the data read out from the TL frame to the external device N.

As such an external device N, for example, an external console is conceivable. It is also conceivable that the console transmits a command in accordance with an operation accepted from a user, to the node B, thereby causing the node B to perform operations such that the node B writes the command into the TL frame and transmits the TL frame to another node to cause the other node to perform operation according to the command, and the node B reads out a response, level data or the like which has been written into the TL frame and transmitted by the other node and transmits it to the console, so as to use it for display of the state of a control or level display in the console.

Of course, it is also possible to perform communication between the console and the node to which the console is connected through a route other than the above-described ring transmission route, and control the operation and the setting contents and so on of the node according to the user's operation accepted by the console.

### 1.2 Configuration of TL Frame

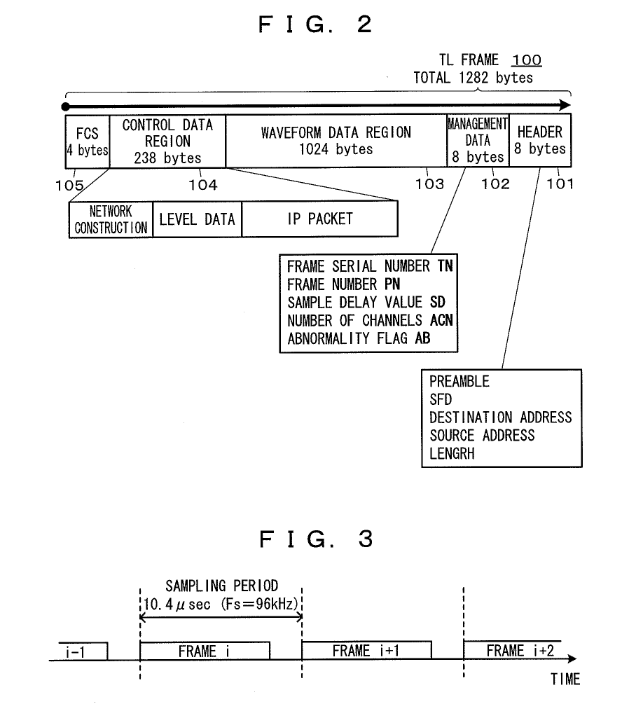

Next, a configuration example of the TL frame that is transported through the above-described transmission routes is shown in FIG. 2. Note that the widths of regions shown in the drawing do not necessarily correspond to data sizes.

As shown in FIG. 2, the TL frame 100 has a size of 1282 bytes, and is composed of regions such as a header 101, management data 102, waveform data (audio data) region 103, control data region 104, and FCS (Frame Check Sequence) 105 in sequence from the head. The size of each region is fixed irrespective of the data amount to be written in the region. Further, the sizes of the regions other than the FCS 105 shown here are just examples and may be changed as required.

The header 101 is data of 22 bytes in total, in which preamble defined by IEEE (Institute of Electrical and Electronic Engineers) 802.3 and SFD (Start Frame Delimiter), a destination address, a transmission source address, and a length indicating the length of the TL frame 100 are written.

Note that it is not so worthwhile to write the address in the audio network system 1 because the frame transmitted from a transmission I/F arrives only at the reception I/F which is connected thereto by one communication cable CB. Hence, for example, a broadcast address is written as the destination address, and a MAC (Media Access Control) address of the transmission source node is written as the transmission source address.

Each of the nodes includes the transmission I/Fs and the reception I/Fs two each, which do not have discrete MAC addresses respectively but have one MAC address as one node. Further, as the destination address, the MAC address of the transmission destination node may be written instead of writing the broadcast address. Furthermore, the ID of each node may be written in place of the MAC address.

Further, the management data 102 is data of 8 bytes, into which a frame serial number TN, a frame number PN in each sampling period, a sample delay value SD, a number of channels ACN of waveform data in the waveform data region 103, and an abnormality flag AB are written as data to be used for management of data included in the TL frame, by each of the nodes in the audio network system 1.

The sample delay value SD here is data indicating a time period in sampling periods required for the waveform data written in a frame by a node to return to the node after circulating through the transmission route. The abnormality flag AB is a flag indicating occurrence or not of abnormality in a specific node on the frame transmission route. The abnormality flag AB will be described later.

As the region of the waveform data 103, 1024 bytes are secured, and waveform data of 32 bits for 1 sample can be written for 256 channels as data of audio signals. In other words, in this system, the audio signals corresponding to the 256 channels can be transported by circulating one TL frame 100. Note that it is not necessary to concern about what is written in regions of channels not in use for the transport (empty channels) among the 256 channels.

Further, as the region of the control data 104, 224 bytes are secured, and there provided are an IP packet region in which various kinds of data such as a packet for inter-node communication based on IP (Internet Protocol) are written, a level data region in which level data used for level display is written, and a network configuration region in which network configuration information for managing and controlling the configuration of the audio network system 1 is written. Here, in the communication by the IP packet, a command for instructing each node to perform operation and a response to the command are transmitted and received among nodes.

Note that the reason why the respective dedicated regions (for example, 10 bytes) are provided for the level data and the network configuration information is to steadily transport those kinds of data.

Regarding the IP packet region among the regions, a packet in the IEEE (Institute of Electrical and Electronic Engineers) 802.3 format that is obtained by further packetizing the IP packet made by packetizing the data to be communicated is divided into blocks such as to fit the prepared size (204 bytes here) and written therein on the transmission side of the packet. Then, the packet destination processor reads out respective blocks from the respective TL frames 100 and combines the blocks together to restore the packet before the division, whereby the IP packet can be transported between the nodes in a similar manner to the regular transport based on the Ethernet (registered trademark). The maximum size of the IEEE 802.3 packet is 1526 bytes. On the other hand, about 200 bytes can be transported for each one TL frame even if division control data of several bytes is added for controlling division and restoration. Accordingly, transport of one IP packet is completed by eight TL frames at maximum.

The FCS 105 is a field for detecting an error of the frame, defined by IEEE 802.3.

### 1.3 Method of Transporting TL Frame

Next, a transport timing of the TL frame 100 shown in FIG. 2 is shown in FIG. 3.

As shown in this drawing, in the audio network system 1, one TL frame 100 is circulated among the nodes every 10.4 μsec (microseconds) that is one period of a sampling period of 96 kHz, and each node writes the audio signals into a desired channel of the TL frame or reads the audio signals from a desired channel. Accordingly, one sample of the waveform data can be transported between the nodes for each of the 256 channels in each sampling period.

When data transfer in the Ethernet (registered trademark) system of 1 Gbps (gigabit per second) is employed, the time length of the TL frame 100 is 1 nanosecond×8 bits×1282 bytes=10.26 μsec, so that the transmission of the TL frame 100 from the master node is completed in one sampling period.

Note that the TL frame having 1282 bytes is adaptable for a sampling period up to 1 sec/10.26 μsec=97.47 kHz, and a frame size up to 10.4 μsec/8 bits/1 nanosecond=1300 bytes can be adaptable for sampling frequency of 96 kHz, in terms of calculation with neglecting intervals between the frames. However, since an empty interval of a predetermined time period or more is necessary between the frames and the transmission timing of the frame can advance or delay, the size (time length) of the TL frame is determined upon consideration of these situations.

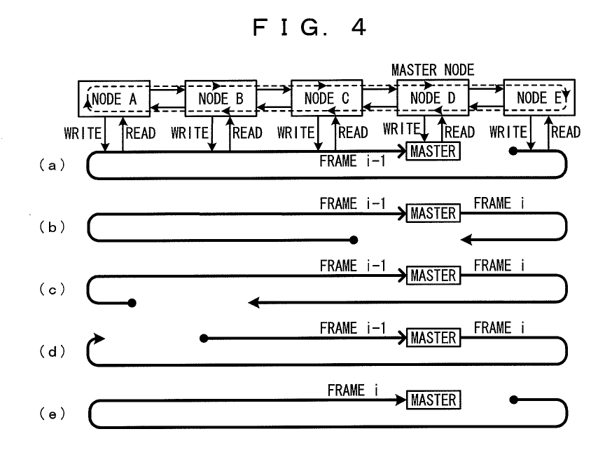

Next, states of the TL frame shown in FIG. 2 during transport of audio signals on the audio network system 1 are shown in FIG. 4.

An audio network system in which five nodes, the node A to the node E, are cascaded is discussed here. When the TL frame 100 shown in FIG. 2 is circulated through the nodes in the system, any one of the nodes is determined as a master node, and only that master node generates the TL frame in a new sampling period (a TL frame with a different serial number) and transmits the generated TL frame to the next node every sampling period. The nodes other than the master node are slave nodes which perform transfer process of receiving the TL frame from their respective preceding nodes and transmitting it to the respective next nodes.

When the master node D first transmits the TL frame, rightward in the drawing, toward the node E in accordance with the timing of a wordclock, the TL frame is transported to the nodes D, E, D, C, B, A, B, C and D in order as shown by the broken line and thus returned to the node D. As seen from the master node, the side on which the master node first transmits the circulating TL frame is called a forward side, and the side on which the master node secondly transmits it is called a backward side. While the TL frame circulates through the transmission route, each node reads, from the TL frame, the waveform data and the control data which the node should receive from another node, and writes, into the TL frame, the waveform data and the control data which the node should transmit to the other node, during the time period that the TL frame is flashing through the node, namely from reception to transmission of each portion of the TL frame in the node.

When the TL frame returns after circulating through the transmission route, the master node overwrites the management data 102 of the TL frame to generate the TL frame in the later sampling period, and provides it to transmission in an appropriate sampling period. In this event, the master node also reads/writes data from/to the TL frame as with the other nodes.

By repeating the above, one TL frame can be circulated for one sampling period, among the nodes as shown in (a) to (e) in time sequence. In these drawings, a black arrow shows the head of the TL frame, a black circle shows the end of the TL frame, and a bold line connected to the black arrow and/or the black circle shows the TL frame itself. The arrow of a line connected to the bold line is indicating the return of the TL frame to the master node after circulating through the transmission route.

Note that each slave node receiving the TL frame, before the node completes receiving all the TL frame (from the head to the tail), starts to read/write data from/to the TL frame from the head and transmit the TL frame from the head to the next node at a timing when the node has received necessary bytes of the TL frame from the head. Thereafter, the slave node reads/writes and transmits the TL frame to the end at substantially the same speed as the node receives the TL frame. On the other hand, the master node receives the whole TL frame and then generates a new TL frame based on the contents of the received frame.

In the cascade, the TL frame flashes through each of the nodes other than nodes at both ends twice in one circulation, but the node reads/writes data from/to the TL frame on only one occasion of them. On which occasion the node reads/writes audio data is selectable. In one case, the node reads/writes audio data at the first time when the TL frame flashes through the node. In another case, the node reads/writes audio data at the time when the TL frame flashes through the node rightward in the drawing. When the node does not read/write audio data from/to the TL frame, the node overwrites only the transmission source address and later-described presence confirmation information in the TL frame and transmits the TL frame to the next node.

Since each node needs to perform buffering at the time of receiving the TL frame, in order to overwrite the data of the TL frame or to absorb the difference in frequency and timing between the network clock on the receiving side (corresponding to the operation clock of the transmission source node) and the network clock on the transmitting side (corresponding to the operation clock of that node), there is a time lag between the timing when the node starts to receive a TL frame and the timing when the node starts to transmit the received frame.

The transport delay (in sampling periods) of the audio signals transported over the network is minimal in a condition that the TL frame transmitted by the master node at a timing of a wordclock in S-th period returns to the master node, after circulating the transmission route, at a timing earlier than a wordclock in (S+2)-th period by a predetermined time a (corresponding to a time necessary to generate a new TL frame in (S+2)-th period based on the received frame in S-th period).

In this case, for example, the (S+2)-th TL frame which will be transmitted 2 sampling periods later is generated based on the S-th TL frame.

In this system, by performing data transport in the above-described method, a fixed transport bandwidth according to the size of the TL frame in the network can be provided at all times. The bandwidth is not affected by magnitude of the data transport amount between specific nodes.

When the nodes shown in FIG. 4 are connected in a loop as shown in FIG. 1B, as is clear from FIG. 1A to FIG. 1C, two transmission routes will be formed. In one transmission route, a TL frame generated and transmitted rightward by the master node D is transported from the node D to the nodes E, A, B, C, and D in order, and in the other transmission route, a TL frame generated and transmitted leftward by the master node D is transported from the node D to the nodes C, B, A, E, and D in order. While the TL frame circulates through the transmission route, each node reads, from the TL frame, the waveform data and the control data which the node should receive from another node, and writes, into the TL frame, the waveform data and the control data which the node should transmit to the other node, during the time period that the TL frame is flashing through the node, namely from reception to transmission of each portion of the TL frame in the node.

In the loop connection, since the TL frame flashes through each of the nodes in the network system once in one circulation through the transmission route, the node reads/writes data from/to the TL frame during the one flash.

The system can selectively perform, as a whole, duplex communication in which the same data is written into the TL frames circulating through the two transmission routes, and double communication in which different data are written into the TL frames circulating through the two transmission routes.

In the case of the duplex communication of them, because the same data is written into the TL frames on the two transmission routes, the data amount transportable per sampling period, that is, the bandwidth of communication is the same as the bandwidth in the case of the cascade connection. However, even if a break of wire occurs at one location, the system can immediately shift to the transport by cascade connection to keep the data transport in the same bandwidth. It is also possible to compare the substance in the TL frames on the two transmission routes to thereby confirm whether or not the data is correctly transported.

On the other hand, in the case of the double communication, because data corresponding to two TL frames can be transported in every sampling period, the bandwidth of communication can be made twice the bandwidth in the case of the cascade connection.

Which one of the duplex communication and double communication is performed may be set in the master node in advance.

### 1.4 Hardware Configuration and Basic Operation of Processors Constituting System

Next, the hardware for transporting the TL frame as has been described above and its operation will be described.

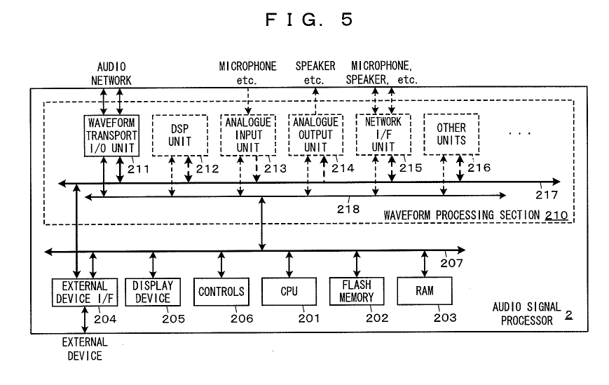

The hardware configuration of an audio signal processor that is each of the nodes constituting the above-described audio network system is shown in FIG. 5.

As shown in FIG. 5, the audio signal processor 2 includes a CPU 201, a flash memory 202, a RAM 203, an external device I/F (interface) 204, a display device 205, and controls 206, which are connected via a system bus 207. The audio signal processor 2 further includes a waveform processing section 210 connecting the external device I/F 204 and the system bus 207.

The CPU 201, which is a controller that comprehensively controls the audio signal processor 2, can execute a required control program stored in the flash memory 202, thereby controlling display on the display device 205, setting the value of the parameter according to the operation of the control 206, controlling the operation of each module, transmitting a command to another audio signal processor via the waveform processing section 210, and performing process according to the command received from the other audio signal processor via the waveform processing section 210.

The flash memory 202 is an overwritable non-volatile memory that stores data which should be left even after the power is turned off, such as the control program executed by the CPU 201.

The RAM 203 is a memory that is used to store data which should be temporarily stored and used as a work memory of the CPU 201.

The external device I/F 204 is an interface for connecting various kinds of external devices to perform inputting/outputting, for example, an external display, a mouse, a keyboard for inputting characters, a control, a PC (personal computer), and the like.

The external device I/F 204 is also connected to an audio bus 217 of the waveform processing section 210 and can transmit the waveform data flowing through the audio bus 217 to the external device and input the waveform data received from the external device into the audio bus 217.

The display device 205 is a display device for displaying various kinds of information according to control by the CPU 201, and can be composed, for example, of a liquid crystal display (LCD), a light emitting diode (LED), or the like.

The controls 206 are used for accepting the manipulation to the audio signal processor 2 and can be composed of various keys, buttons, dials, sliders, and the like.

The waveform processing section 210 is an interface including the audio bus 217 and a control bus 218, and making it possible to input/output the audio signals and the control signal to/from the audio signal processor 2 and perform process on them by providing various kinds of units connected to these buses. The various units provided in the waveform processing section 210 transmit/receive the waveform data to/from each other via the audio bus 217 and transmit/receive the control signal to/from the CPU 201 via the control bus 218 to be controlled by the CPU 201. Note that these units can be configured as detachable card modules.

The audio bus 217 is an audio signal transporting local bus which transports the waveform data of a plurality of channels from an arbitrary unit to an arbitrary unit sample by sample in a time division manner at a sampling period based on the wordclock. Any one of the plurality of connected units becomes a master, and the reference timing for the time division transport of the audio bus 217 is controlled based on the wordclock generated and supplied by that unit. The other units become slaves and generate wordclocks of the units based on the reference timing.

More specifically, the wordclock generated in each unit is a common clock in synchronization with the wordclock of the unit which has become the master, and a plurality of units in a node process the waveform data at a common sampling frequency. Each unit further transmits and receives the waveform data processed based on its own wordclock and the waveform data which should be processed, to/from the other unit via the audio bus 217 at a time division timing based on the above-described reference timing.

FIG. 5 shows, as examples provided in the waveform processing section 210, a waveform transport I/O unit 211, a DSP (digital signal processor) unit 212, an analog input unit 213, an analog output unit 214, and a digital input/output unit 215, and other units 216.

Each of the various units provided in the waveform processing section 210 executes process on the waveform data according to the function of that unit at a timing based on the wordclock (sampling period of the waveform data).

The waveform transport I/O unit 211 among them includes two sets of transmission I/Fs and reception I/Fs and has a function of transporting the TL frame 100 which has been described using FIG. 1A to FIG. 4, and reading/writing the waveform data, the control data and the like from/to the TL frame 100. Details of the function will be described later.

The DSP unit 212 is a signal processor which performs various kinds of process including mixing, equalizing, and effect addition on the waveform data acquired from the audio bus 217 at a timing based on the wordclock. They output the processed data to the audio bus 217. They can further accept inputs of the waveform data of a plurality of channels and process the waveform data and then output the waveform data of a plurality of channels.

The analog input unit 213 includes an A/D (analog/digital) conversion circuit and has a function of converting the analog audio signals inputted from the audio input device such as a microphone to digital waveform data and supplying it to the audio bus 217.

The analog output unit 214 includes a D/A (digital/analog) conversion circuit and has a function of converting the digital waveform data acquired from the audio bus 217 to analog audio signals and outputting them to the audio output device such as a speaker.

The digital input/output unit I/F 215 has a function of supplying the digital audio signals (waveform data) inputted from the audio input device to the audio bus 217 and a function of outputting to the audio output device the waveform data acquired from the audio bus just in the form of the digital signals.

Any of the input/output units can process the signals of a plurality of channels in parallel.

Conceivable other units 216 include units having functions of a sound source, a recorder, an effector and so on.

At least one waveform transport I/O unit 211 is necessary for the audio signal processor 2 to function as a node constituting the audio network system 1. Other units can be arbitrarily selected and provided in the audio signal processor 2 according to demand for the function.

For example, if the DSP unit 212 is provided, the audio signal processor 2 serves as a signal processing engine which reads the audio signals from the TL frame, performs signal processing according to the predetermined value of parameter on the audio signals, and writes the processed audio signals into the TL frame.

If the analog input unit 213 is provided, the audio signal processor serves as an input device which writes the audio signals inputted from the external of the audio network system 1 into the TL frame. If the analog output unit 214 is provided, the audio signal processor serves as an output device which outputs the audio signals read from the TL frame to the external of the audio network system 1. If the digital input/output unit 215 is provided, the audio signal processor serves both as an input device and an output device.

As a matter of course, a plurality of the above-described functions can be provided in one processor by providing a plurality of units in the processor.

Note that the units provided in the waveform processing section 210 as described above perform process on the audio signals according to the common wordclock, and when the audio signal processor 2 is the master node, any one of the provided units supplies the wordclock to the other units including the waveform transport I/O unit 211, and the waveform transport I/O unit 211 transmits, as the master node, a TL frame in each sampling period. When the audio signal processor 2 is a slave node, the waveform transport I/O unit 211 generates (reproduces) the wordclock based on the reception timing of the TL frame and supplies the wordclock to the other units provided in the waveform processing section 210.

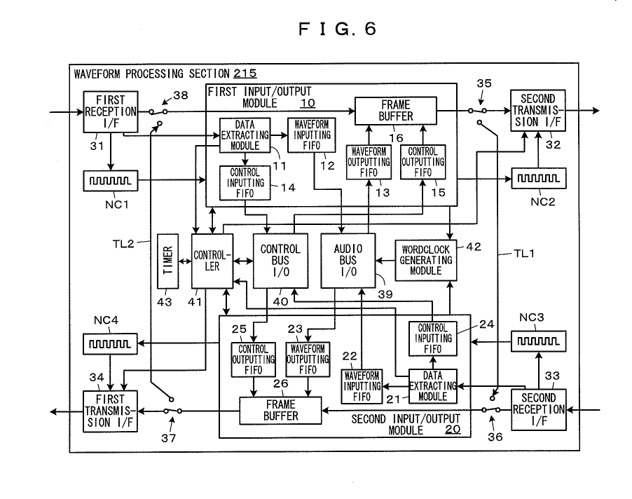

Next, configuration of the waveform transport I/O unit 211 is shown in more detail in FIG. 6.

As shown in FIG. 6, the waveform transport I/O unit includes first and second data input/output modules 10 and 20, first and second reception I/Fs 31 and 33, first and second transmission I/Fs 34 and 32, selectors 35 to 38, an audio bus I/O 39, a control bus 40, a controller 41, a wordclock generating module 42 and a timer 43.

Among them, the first and second reception I/Fs 31 and 33, and the first and second transmission I/Fs 34 and 32 are communication devices corresponding to the two sets of reception I/Fs and transmission I/Fs shown in FIG. 1A to FIG. 1C, each including a predetermined connector (a female side) for connecting a communication cable thereto. For connection of the communication cable, the first reception I/F 31 and the first transmission I/F 34 shall be one set, and the second transmission I/F 32 and the second reception I/F 33 shall be one set. Any communication system can be adopted for these I/Fs as long as they have enough ability for transport of the TL frame in the above-described one sampling period, and an I/F performing data transfer by the Ethernet system of 1 Gbps is employed here.

Currently, the 1G Ethernets include two kinds, such as 1000BASE-T using a CAT5e cable with an RJ45 connector (an unshielded twisted pair cable) as the communication cable CB, and 1000 BASE-X using an optical fiber or an STP cable (a shielded twisted pair cable), any of which can be used in this embodiment. Further, broadband network technologies other than the 1 G Ethernet may be used. For example, they are FiberChannel, SDH (Synchronous Digital Hierarchy)/SONET (Synchronous Optical NETwork) and so on.

The reception I/F extracts the network clock being a carrier from an electric signal or an optical signal propagating through the communication cable CB, and demodulates and outputs a data stream of the digital data in a byte unit (or word unit) from the electric signal or the optical signal based on the extracted clock. The transmission I/F receives the network clock and the digital data stream in a byte unit (or word unit) which should be transmitted, and modulates it to an electric signal or an optical signal for transport using the network clock as a carrier and outputs it to the communication cable CB.

Further, the audio bus I/O 39 is an interface for inputting/outputting waveform data to/from the audio bus 217.

The control bus I/O 40 is an interface for inputting/outputting data such as control packet, level data, network configuration information and so on to/from the control bus 218.

The controller 41 has a CPU, a ROM, a RAM and the like and performs general control relating to operation of the waveform transport I/O unit 211 and control relating to formation of the transmission routes for the TL frame though detail description thereof is omitted. Further, the controller 41 can also transmit/receive data to/from the CPU 201 via the control bus I/O 40 and the control bus 218.

The wordclock generating module 42 is a wordclock generating device that generates the wordclock being a reference of timings for transfer of the waveform data in the audio bus 217 and signal data processing in various kinds of units connected to the audio bus 217.

The wordclock generating module 42 in a master node generates the wordclock at its own timing of the waveform transport I/O unit 211 or a timing in synchronization with the wordclock supplied via the audio bus 217 from the other unit, and uses the clock as reference of transmission timing of TL frames, whereas the wordclock generating module 42 in a slave node generates the wordclock using reception timing of TL frames as a reference.

The timer 43 is a timekeeper measuring elapsed time. The CPU 201 periodically resets the timer 43 via the controller 41 when there is no abnormality in operation of the audio signal processor 2, as described later, so that the controller 41 can detect occurrence of abnormality using the fact that the count by the timer 43 reaches a predetermined value as a trigger.

Each of the first and second data input/output modules 10 and 20 operates based on an operation clock generated by a not-shown operation clock generating module, and functions as a reader that reads desired data from various kinds of frames (including the TL frame) received by a corresponding reception I/F, and a writer that writes desired data into the received TL frame. The functions of these first and second data input/output modules are identical, and therefore the first data input/output module 10 will be described as a representative.

The first input/output module 10 includes a data extracting module 11, a waveform inputting FIFO 12, a waveform outputting FIFO 13, a control inputting FIFO 14, a control outputting FIFO 15, a frame buffer 16, and a waveform data comparing module 17. The first input/output module 10 receives the data from the first reception I/F 31 in synchronization with a network clock NC1 extracted at the first reception I/F 31 as a carrier and supplied to the first reception I/F 31. Each FIFO here is a register of first-in/first-out in which firstly written data is firstly read out.

In other words, the data extracting module 11 and the frame buffer 16 retrieve the data outputted from the first reception I/F 31 in synchronization with the network clock NC1 (it is assumed here that the input from the reception I/F 31 is selected by the selector 38). Note that only the TL frame is retrieved into the frame buffer 16, whereas data not described here other than the TL frame is also retrieved into the data extracting module 11.

Among them, the data extracting module 11 has a function of writing, into the waveform inputting FIFO 12, waveform data of a transport channel to be read out and supplied to the audio bus 217 among the retrieved data, writing waveform data of a transport channel which will be overwritten in the first data input/output module 10 into the waveform data comparing module 17, writing the control data to be read out into the control inputting FIFO 14, and discarding the other data.

The waveform data of each transport channel written into the waveform inputting FIFO 12 is read out by the audio bus I/O 39 sample by sample in synchronization with the wordclock, and transported to another unit via the audio bus 217. The control data written into the control inputting FIFO 14 is read out in sequence by the CPU 201 via the control bus I/O 40 and used for control of the audio signal processor 2.

For the waveform data to be received from another node, the controller 41 grasps at least the transport channel number of the waveform data to be read out, therefore can calculate byte positions of the waveform data in the TL frame based on the channel number. The controller 41 indicates the positions to the data extracting module 11 and instructs it to write only the data at necessary positions into the waveform inputting FIFO 12 and the waveform data comparing module 17.

For the control data, the data extracting module 11 does not make judgment but writes the retrieved data, if it is control data, into the control inputting FIFO 14, and the CPU 201 reads out the control data from the control inputting FIFO 14 and analyses the transmission destination address and the like contained in the control data to judge whether or not it is the control data to be referred to.

As has been described above, as regards transport of the control data a packet may be divided into a plurality of portions on the transmission side and transmitted as control data, and it is preferable to leave the judgment to the CPU 201 in order to flexibly cope with such data. Alternatively, a function of processing such divided packet may be imparted to the data extracting module 11, and the controller 41 in the processor indicates the address of the processor to the data extracting module 11 to enable the data extracting module 11 to judge whether or not the control data is addressed to the node based on a matching of the transmission destination address contained in the control data with the address of the processor.

On the other hand, the waveform outputting FIFO 13 is a buffer that stores waveform data to be written in the TL frame and outputted, and the audio bus I/O 39 acquires waveform data to be outputted in each sampling period from the audio bus 217 and writes the data therein. It is of course possible to write waveform data corresponding to a plurality of transport channels, and it is only necessary to firstly write, into the waveform outputting FIFO 13, data to be written into a byte close to the head of the TL frame.

Further, the control outputting FIFO 15 is a buffer that stores control data to be written into the TL frame and outputted, and the control bus I/O 40 acquires control data to be outputted from the control bus 218 and writes the data therein.

In the case where the processor is a slave node, when a predetermined amount (a first predetermined amount) of data of the TL frame is accumulated (stored) in the frame buffer 16, the data in the waveform outputting FIFO 13 and the control outputting FIFO 15 is written into an appropriate address of the frame buffer 16 in accordance with progression of the accumulation whereby contents of the TL frame are overwritten.

For the waveform data to be transported to other node, the controller 41 calculates the byte positions of the waveform data in the TL frame, based on the transport channel into which the waveform data should be written, and indicates it to the frame buffer 16, and the frame buffer writes the waveform data supplied from the outputting FIFO 15 into the byte positions in the TL frame. Also for the control data, the byte positions in the TL frame which the data should be written into is automatically determined for each kind of data according to the frame construction shown in FIG. 2. When it is desired to transport another kind of data, a portion of the region of “IP packet” may be used as a region for that another kind of data.

In the case where the processor is a slave node, when a second predetermined amount, which is larger than the first predetermined amount, of data of the TL frame is accumulated in the frame buffer 16, the frame buffer 16 starts outputting the TL frame so that if the selector 35 selects output to the second transmission I/F 32, the frame buffer 16 passes the data of the TL frame to the second transmission I/F 32 in sequence from its head to cause the second transmission I/F 32 to transmit the data.

In this event, the operation clock of the first data input/output module 10 is supplied as it is as a network clock NC2 to the second transmission I/F 32, and the second transmission I/F modulates in sequence the data of the TL frame using the network clock NC2 as a carrier and outputs it to the communication cable CB.

In this case, the first data input/output module 10 functions as a transmission controller.

Incidentally, although the process for overwriting contents of the TL frame stored in the frame buffer 16 with the data from the waveform outputting FIFO 13 and the data from the control outputting FIFO 15 and the process for outputting the TL frame from the frame buffer 16 are individually performed in this embodiment, the overwriting process and the outputting process may be performed at a time. In this variation, the received TL frame is written into the frame buffer 16, a reading out process of the TL frame in the frame buffer 16 is started using the accumulation up to the predetermined amount as a trigger, and the TL frame read out is supplied to the second transmission I/F 32 while some portions of the TL frame are being replaced with the data from the waveform outputting FIFO 13 and the data from the control outputting FIFO 15.

Further, it is also acceptable that the process of overwriting the data in the TL frame is not performed after the TL frame received once is stored in the frame buffer 16, but the overwriting process could be performed before the frame is stored in the frame buffer. In this variation, an appropriate one of the data from the first reception I/F 31, the data from the waveform outputting FIFO 13, and the data from the control outputting FIFO 15 is selected and written at the time of writing the TL frame into the frame buffer 16. In this case, the data which has not been selected among the data in the TL frame supplied from the first reception I/F 31 is discarded.

In the case of the cascade as described above, each node reads/writes only once while the TL frame circulates once through the transmission route. Accordingly reading/writing of the data is performed in only one of the first and second data input/output modules 10 and 20. When the data input/output module performs neither the reading nor writing, the TL frame just flashes therethrough. Note that the FIFOs 22, 23, and 25 are not necessary in this embodiment because the data just flashes through the frame buffer 26, but these FIFOs are provided to enable the audio network system 1 to operate in the loop connection.

In addition, the data input/output module reading out data from the TL frame may stop writing data into the TL frame from the waveform outputting FIFO and the control outputting FIFO according to operation status of the audio signal processor 2, as will be described later. The control of the stop is conducted by the controller 41.

The master node updates the TL frame after completion of the reception of the whole TL frame, so the timing of writing data into the TL frame and the timing of starting transmission of the TL frame are different from those of the slave node. However, the position for writing data in the TL frame can be determined as in the case of the slave node. The master node also rewrites the management data 102 in the TL frame, and the rewrite can also be performed such that data to be described into a new TL frame is written into the control outputting FIFO 15 and the data is written over that in the TL frame accumulated in the frame buffer.

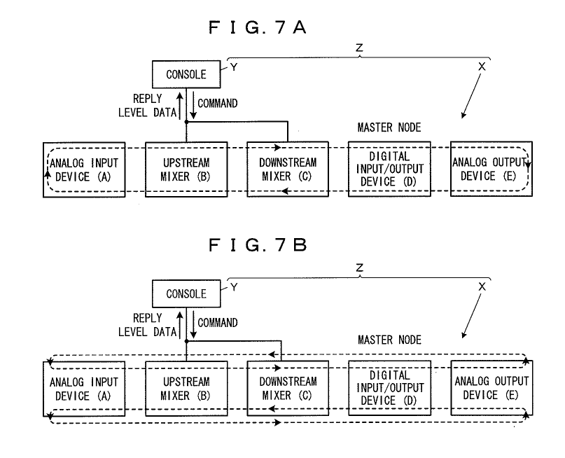

Further, the waveform data comparing module 17 is a functional module which operates when two signal processing engines are provided in a pair in the audio network system 1 as described later to make the system fault-tolerant. The waveform data comparing module 17 compares waveform data of a certain transport channel to be overwritten in the first data input/output module 10, which has been inputted from the data extracting module 11, with waveform data which has been written in the waveform outputting FIFO 13 and should be written into the same transport channel. However, a read address of the data from the waveform outputting FIFO 13 for the comparison is managed by separately preparing a read address register to prevent influence on the FIFO operation for writing the waveform data. Further, the meaning of comparison by the waveform data comparing module 17 will be described later in the description using FIG. 7A to FIG. 9.

The foregoing is the function of the data input/output module relating to transmission of the TL frame.

Besides, as can be seen from FIG. 1A and the like, the transmission destination of TL frames from a node that has received it may be a node other than the transmission source of the TL frame (the case of the node B in FIG. 1A) or may be the same node as the transmission source (the case of the nodes A and C). In the former case, the TL frames are transmitted from a transmission I/F in another set different from the set of the reception I/F which has received the TL frames, whereas in the latter case, they are transmitted from a transmission I/F in the same set.

The selectors 35 to 38 are provided to switch the transmission destination as described above.

The selector 35 and the selector 36 cooperate such that when the selector 35 sends output of the frame buffer 16 to the second transmission I/F 32, the selector 36 sends data received at the second reception I/F 33 into the frame buffer 26 to write the data therein so as to make the node possible to communicate with the node on the second I/F side.

When the selector 35 and the selector 36 are switched to a loopback line TL1 side, the output of the frame buffer 16 is written into the frame buffer 26 and passed to the first transmission I/F 34 therefrom and transmitted to the connection destination. Accordingly, received TL frames will be transmitted back to their transmission source. It is also adoptable to configure such that, in this event, the data is not written into the frame buffer 26 but just passes through it so that the output of the frame buffer 16 can be directly passed to the first transmission I/F 34. The operation clock of the first data input/output module 10 which supplies the data to be transmitted can be supplied as the network clock, and if the first data input/output module 10 and the second data input/output module 20 are operated by common operation clock, it is not necessary to switch the supply source of the network clock.

In this state, even if the second reception I/F 33 receives some frame, its contents are not written into the frame buffer 26. However, the contents are written into the data extracting module 21, and the data extracting module 21 inputs all the contents into the controller 41. In this state, the output of the frame buffer 16 is not supplied to the second transmission I/F 32, but a line to pass the data directly from the controller 41 to the second transmission I/F 32 for transmission is provided.

Though detailed description will be omitted, these input/output lines are used for transmission/reception of notifications and commands when assembling the audio network system in the initial processing and performing processing relating to change of the system configuration (addition of nodes and the like).

Although the selectors 35 and 36 have been described here, the selectors 37 and 38 operate in cooperation and thereby have a similar function. They can switch whether or not to perform loopback for the TL frame received from the second reception I/F 33.

In summary, in the audio signal processor 2, the hardware of the waveform transport I/O module 211 shown in FIG. 6 performs the processing in on of the following Table 1 and Table 2 according to the detected event, depending on the connection state of each node in the audio network system in which the processor is included, and on whether the processor is a master node or a slave node, whereby the function relating to transmission of the TL frame and data as described using FIG. 1A to FIG. 4 can be realized.

Incidentally, these tables show an example in which the first data input/output module 10 is used for input/output of data at all times, and if using the second data input/output module 20, it is only required to swap the contents of processing between the first data input/output module 10 and the second data output/output section 20 such that the functions of the first data input/output module 10 and the second data output/output section 20 are reversed. Further, processing relating to the functions of the waveform data comparing modules 17 and 27 is not described in these tables.

TABLE 1
Frame Transport Processing Performed by Hardware of Master Node

| Detected Event | Processing to be Executed |
|---|---|
| Reception of Frame from | Receive Each Data of Frame in |
| First Reception I/F | Sequence, while Writing That Data |
| | into Data Extracting Module 11 and |
| | Frame Buffer 16 |
| Presence of Data in Data | Write Data to be Received, into |
| Extracting Module 11 | Waveform Inputting FIFO 12 or |
| | Control Inputting FIFO 14 |
| Completion of Reception of | Update Management Information of |
| One TL frame at | Received S-th TL Frame, and Write, into |
| First Reception I/F | Appropriate Position of That Frame, Data |
| | to be Transmitted Which is Obtained |
| | from Waveform Outputting FIFO 13 and |
| | Control Outputting FIFO 15, to Generate |
| | (S + k)-th TL Frame (for example, k = 2) |
| Reception of Wordclock | Read out Data of TL frame to be |
| | Transmitted Next in Sequence from Head |
| | from Frame Buffer 16, and Transmit That |
| | Data by Second Transmission I/F |
| | (Non-Loopback State) or Write Contents |
| | Into Frame Buffer 26 (Loopback State) |
| Reception of Frame from | Receive Each Data of Frame in |
| Second Reception I/F | Sequence, while Writing That Data into |
| | Frame Buffer 26 |
| Presence of Data | Read out Data Stored in Frame Buffer 26 |
| in Frame Buffer 26 | in Sequence from Head, and Transmit |
| | That Data by First Transmission I/F |
| | (Non-Loopback State) or Write Contents |
| | into Frame Buffer 16 (Loopback State) |

TABLE 2
Frame Transport Processing Performed by Hardware of Slave Node

| Detected Event | Processing to be Executed |
|---|---|
| Reception of Frame from | Receive Each Data of Frame in |
| First Reception I/F | Sequence, while Writing That Data into |
| | Data Extracting Module 11 and |
| | Frame Buffer 16 |
| Presence of Data in Data | Write Data to be Received into Waveform |
| Extracting Module 11 | Inputting FIFO 12 or |
| | Control Inputting FIFO 14 |
| Presence of First | Write, into Appropriate Position of Frame |
| Predetermined Amount | Written in Frame Buffer 16, Data to be |
| of Data in Frame Buffer 16 | Transmitted Which is Obtained from |
| | Waveform Outputting FIFO 13 and |
| | Control Outputting FIFO 15 |
| Presence of Second | Read out Data of Frame Buffer 16 in |
| Predetermined Amount of | Sequence from Head, and Transmit That |
| Data in Frame Buffer 16 | Data by Second Transmission I/F |
| | (Non-Loopback State) or Write Contents |
| | into Frame Buffer 26 (Loopback State) |
| Reception of Frame from | Receive Each Data of Frame in |
| Second Reception I/F | Sequence, while Writing That Data into |
| | Frame Buffer 26 |
| Presence of Data | Read out Data of Frame Buffer 26 in |
| in Frame Buffer 26 | Sequence from Head, and Transmit That |
| | Data by First Transmission I/F |
| | (Non-Loopback State) or Write Contents |
| | into Frame Buffer 16 (Loopback State) |

Therefore, the waveform transport I/O module 211 can perform at least transmission of the TL frame itself by the function included in its own hardware even if abnormality occurs in other parts of the audio signal processor 2 as long as power is supplied thereto, appropriate cables are connected to the I/Fs 31 to 34, and the wordclock can be generated, or is supplied from the control bus 218 when the processor is the master node.

### 2. Configuration Example of Fault-tolerant Audio Network System

### 2.1 Functions and Connection Order of Nodes

Next, a configuration example of a concrete system when the above-described audio network system is constructed to be fault-tolerant will be described.

The configuration examples of the system are shown in FIGS. 7A and 7B.

FIGS. 7A and 7B each show a mixer system Z in which a console Y as an external device is connected to nodes B and C serving as mixers for an audio network system X composed of five nodes A to E. In FIGS. 7A and 7B, a transmission route for the TL frames in the case of cascade connection is shown by a broken line in FIG. 7A, whereas transmission routes in the case of the loop connection are similarly shown by broken lines in FIG. 7B, and other points are common to these two systems.

The five nodes constituting the audio network system X are an analog input device A, an upstream mixer B, a downstream mixer C, a digital input/output device D, and an analog output device E respectively. Among them, the analog input device A includes the analog input unit 213 shown in FIG. 5, the upstream mixer B and the downstream mixer C include DSP units 212, the digital input/output device D includes the digital input/output unit 215, and the analog output device E includes the analog output unit 214.

Though any node may become the master node, the digital input/output device D shall be the master node here.

The mixer system Z, as a whole, has a function of processing audio signals inputted through the analog input device A and the digital input/output device D by the upstream mixer B and the downstream mixer C, and outputting the processed audio signals from the digital input/output device D and the analog output device E.

As has been described, at the time when one TL frame transmitted from the master node circulates through the ring transmission route, the TL frame flashes through each node once or twice. Each node writes/reads data to/from the TL frame during one flash or one of two flashes. This means that processors perform write/read processing in order regarding the one TL frame circulating through the ring transmission route.

The order of processing is referred to as a frame processing order on the ring transmission route. Further, nodes preceding in the frame processing order are referred to as “upstream” nodes, and nodes subsequent in the frame processing order are referred to as “downstream” nodes.

Note that the frame processing order does not always coincide with the connection order of the nodes. For example, for the cascade connection, when a node reads/writes data from/to the TL frame by the first data input/output module 10 and another node reads/writes data from/to the TL frame by the second data input/output module 20, the frame processing order is different from the connection order of nodes. What is important in this embodiment is not the connection order of nodes but the upstream/downstream relation in terms of the frame processing order.

Further, for the loop connection, the upstream/downstream relation between the two mixers is changed depending on the transmission route. In the example shown in FIG. 7B, the mixer B is upstream in the upper transmission route in the drawing, whereas the mixer C is upstream in the lower transmission route in the drawing. Therefore, for the loop connection, it is necessary to manage the upstream/downstream relation for each transmission route and conduct control according to the relation.

In the mixer system Z, the upstream mixer B and the downstream mixer C are provided as nodes consecutive (another node never reads/writes between them) in the frame processing order. Further, the upstream mixer B and the downstream mixer C have completely the same configurations regarding at least the waveform transport I/O unit 211 and the DSP unit 212, and read the waveform data in the same transmission channel of the TL frame and perform the same signal processing on the waveform data. Not only the kinds and procedure of signal processing but the parameters in use are the same.

Further, the console Y is also connected to both the upstream mixer B and the downstream mixer C so that the same values of the parameters for use in the signal processing in the DSP units 212 and the parameters for use in reading of the waveform data from the TL frame in the waveform transport I/O units 212 can be set in the upstream mixer B and the downstream mixer C according to the operation of the user.

One of the above-described upstream mixer B and the downstream mixer C is used as a mixer of an active system (a first signal processing engine) which reflects the processing result in the output to the external of the system, and the other is used as a mixer of a standby system (a second signal processing engine) for backup which does not reflect the processing result in the output to the external of the system if there is no problem in operation of the system but, if an abnormality has occurred in the mixer of the active system, serves as a mixer of the active system instead. This makes the mixer system Z fault-tolerant configuration in which even if an abnormality has occurred in one of the two mixers, normal output audio signals can be continuously obtained.

The functions of the active system and the standby system can be basically realized in the similar manner in both of the cases of the cascade connection shown in FIG. 7A and the loop connection shown in FIG. 7B. In the loop connection, it is only required to conduct the same control of writing the waveform data as that in the cascade connection for each of the two transmission routes. That is, in the loop connection, it is enough to conduct the control relating to each of the transmission routes on the data input/output module corresponding to the transmission route, because the two data input/output modules will take charge of reading/writing data on the different transmission routes in each node.

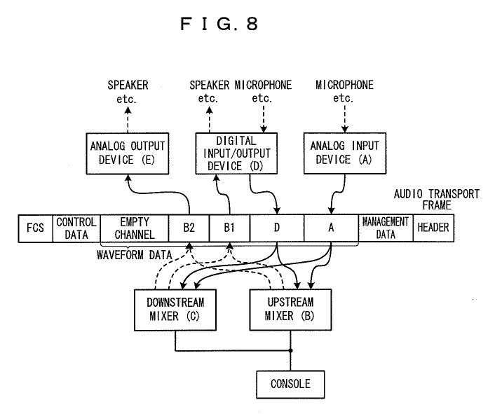

Next, FIG. 8 shows outline of reading/writing of the waveform data from/to the TL frame performed by each of the nodes shown in FIGS. 7A and 7B. Note that the positional relation of nodes and arrows shown in the drawings does not indicate the temporal sequence relation of reading/writing. The reading and writing of waveform data by each node are performed when a portion corresponding to a relevant transmission channel of the TL frame flashes through the node.

As shown in FIG. 8, in the mixer system Z, the analog input device A and the digital input/output device D write audio signals inputted from an external device such as a microphone into regions of a predetermined transmission channel of the TL frame, respectively.

In FIG. 8, the region into which the analog input device A writes waveform data is shown by a symbol A, and the region into which the digital input/output device D writes waveform data is shown by a symbol D. Further, in FIG. 8, the regions into which the analog input device A and the digital input/output device D write the waveform data are shown as continuous regions, but not limited to such regions and may be separate regions. Further, it is not required to write waveform data into all of the previously prepared regions. This also applies to the regions shown by the following symbols B1 and B2.

Then, the upstream mixer B and the downstream mixer C read the waveform data written by the analog input device A and the digital input/output device D from the TL frame, perform signal processing on the waveform data in the DSP units 212, and write the processed waveform data into the regions of the predetermined channel of the TL frame.

Further, the digital input/output device D and the analog output device E read the waveform data written by the upstream mixer B and the downstream mixer C from the TL frame, and output the waveform data to an external device such as a speaker as digital or analog audio signals. In the drawing, the region from which the digital input/output device D reads the waveform data is shown by the symbol B1, and the region from which the analog output device E reads the waveform data is shown by the symbol B2. Further, the upstream mixer B and the downstream mixer C write the processed waveform data for a plurality of channels dividedly into the regions B1 and B2 according to the processor which will read the waveform data.

Note that when the upstream mixer B and the downstream mixer C write the waveform data into the TL frame, both of them write the waveform data into the region of the same relevant transmission channel in the region B1 or B2. Therefore, when the downstream mixer C writes the waveform data, the waveform data processed by the downstream mixer C will be written over the waveform data which has been written by the upstream mixer B.

Further, as shown in FIGS. 7A and 7B, other nodes never write the waveform data into the TL frame between the upstream mixer B and the downstream mixer C. Therefore, when the two mixers read the waveform data from the region of the same transmission channel (limited to the channel into which the mixers themselves do not write) of the TL frame, completely the same waveform data can be acquired. Accordingly, when the two mixers perform the same signal processing on the waveform data, completely the same waveform data will be acquired as the processing result. Furthermore, other nodes never read the waveform data from the TL frame between the upstream mixer B and the downstream mixer C, so that which of the two mixers writes the processing result into the TL frame never exerts influence on the operation of the other nodes.

In consideration of the above point, one (or both) of the mixers is(are) determined to write waveform data into the TL frame in the mixer system Z, according to which of the upstream mixer B or the downstream mixer C is used as the active system. If a failure occurs in the mixer of the active system, the mixer used as the standby system thus far will be used as the mixer of the active system. Switching between the mixers can be realized by appropriately changing which of the mixers takes part of writing waveform data into the TL frame.

2.2 Outline of Control for Switching between Active System and Standby System

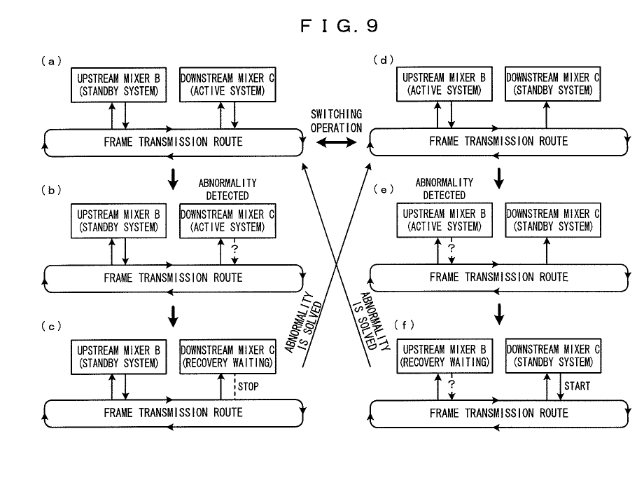

Next, setting of write or not at the upstream mixer B and the downstream mixer C according to the situation will be described using FIG. 9.

In the drawing, a rounded rectangle with arrows shows one frame transmission route, arrows directing from the mixers to the transmission route show writing of waveform data into TL frames, and arrows directing from the transmission route to the mixers show reading of waveform data from TL frames.

First, when the downstream mixer C is used as the active system as shown at (a) in FIG. 9, at least the downstream mixer C writes waveform data into TL frames to transport the processing result by the downstream mixer C being the active system to other nodes. In this case, though the situation is the same whether the upstream mixer B writes waveform data into TL frames or not in consideration of transport of the waveform data (because the waveform data is written over by the downstream mixer C), the upstream mixer B writes waveform data into TL frames here.

The reason is to enable to detect abnormality in operation of the mixer using the function of the waveform comparing module 17 shown in FIG. 6. More specifically, as long as both the upstream mixer B and the downstream mixer C normally operate, waveform data written into TL frames after the upstream mixer B performs signal processing and corresponding waveform data written into TL frames after the downstream mixer C performs signal processing should have the same contents. Conversely, if an abnormality has occurred in operation of either the upstream mixer B or the downstream mixer C, in particular, in signal processing operation by the DSP unit 212, a difference possibly occurs between contents of the waveform data.

Therefore, the abnormality in operations of the upstream mixer B and the downstream mixer C can be detected by operating the waveform data comparing module 17 in the downstream mixer C to compare the waveform data which has been written by the upstream mixer B, that is, the waveform data written at the position of the transmission channel into which the downstream mixer C will write data in the TL frame received by the downstream mixer C, with the waveform data which the downstream mixer C is to write into the same TL frame. If there is no difference between the waveform data, both the upstream mixer B and the downstream mixer C have no abnormalities, whereas if there is a difference therebetween, either the upstream mixer B or the downstream mixer C has an abnormality.

However, mixer having an abnormality cannot be determined only by the comparison. Therefore, to specify the mixer in which an abnormality has occurred, another check is required. Alternatively, some fuzziness is given to the judgment for a match so that when the difference between values of data falls within a predetermined error span, it may be regarded as a match.

Further, the user can manually switch between a mixer for use as the active system and a mixer for use as the standby system through the operation from the console Y.

The state where the switching is performed, that is, the state where the upstream mixer B is used as the active system and the downstream mixer C is used as the standby system is shown at (d).

In this case, the upstream mixer B writes waveform data into TL frames, whereas the downstream mixer C does not write waveform data. Therefore, processing result by the upstream mixer B will be transported to other nodes. Note that not only the upstream mixer B but also the downstream mixer C read the waveform data from TL frames in order to use the function of the waveform data comparing module 17.

Accordingly, to shift the system from the state shown at (a) to the state shown at (b), it is only required to cause the downstream mixer C to stop writing waveform data into TL frames. Conversely, to shift the system from the state shown at (d) to the state shown at (a), it is only required to cause the downstream mixer C to start writing waveform data into TL frames.

Note that, as is clear from the above description, the abnormality detecting function by the waveform comparing module 17 can be similarly exhibited irrespective of whether the downstream mixer C writes waveform data or not.

Further, the state shown at (a) need not be the initial state, but the state shown at (d) may be the initial state.

In the state shown at (a), if an abnormality has been detected in the operation of the downstream mixer C that is the active system as shown at (b), it cannot be assured any longer that properly signal-processed waveform data is written into TL frames.

Hence, in this case, writing of waveform data into TL frames by the downstream mixer C is stopped as shown at (c). In this state, the waveform data which has been written into the TL frames by the upstream mixer B reaches the downstream output device. Thus, the output device can output appropriate waveform data to the external as before even when abnormality occurs in the downstream mixer C, while continuing the same operation as before the abnormality occurs.

The time period required to switch the active system is within one sampling period, and estimated loss of data is 0 to 1 sample. Accordingly, the loss only generates noise or blank hardly caught by human ears, so that the system can continue the output as before occurrence of abnormality.

In this state, the upstream mixer B will serve as the active system. On the other hand, the downstream mixer C cannot serve as the standby system as it stands because an abnormality has occurred therein. However, if the abnormality is solved automatically or manually, or if it is confirmed that the detection of the abnormality was an error and there is no problem in operation of the mixer, the downstream mixer C can be used as the standby system.

As is clear from the drawing, the state shown at (c) is completely the same as the state shown at (d) if the abnormality in the downstream mixer C is solved. Accordingly, when the abnormality in the downstream mixer C has been solved, the system can be handled as has been shifted to the state at (d) without performing specific process.

In the state shown at (d), when an abnormality is detected in operation of the upstream mixer B that is the active system as shown at (e), it cannot be assured any longer that properly signal-processed waveform data is written into TL frames.

Hence, in this case, writing of waveform data into TL frames by the upstream mixer C is started as shown at (f). In this state, the waveform data which has been written into the TL frame by the upstream mixer B is overwritten and the waveform data which has been written by the downstream mixer C reaches the downstream output device. Thus, the output device can output appropriate waveform data to the external as before even when abnormality occurs in the upstream mixer B, while continuing the same operation as before the abnormality occurs. In this case, it is not necessary to stop writing of waveform data by the upstream mixer B.

The time period required to switch the active system is within one sample period, and estimated loss of data is 0 to 1 sample also in this case. Accordingly, the loss only generates noise or blank hardly caught by human ears, so that the system can continue the output as before occurrence of abnormality.

Further, the downstream mixer C will serve as the active system in the state at (f). Further, if the abnormality in the upstream mixer B has been solved, the system shifts to the state shown at (a) in which the upstream mixer B can be used as the standby system based on the similar concept as that in the above-described case of (c).

Note that in the above-described control of switching, it is assumed that at least capability of transmitting TL frames is maintained in the nodes including the mixers (it is conceivable that an abnormality occurs in reading/writing of the data in this state). Further, appropriate shift between states is impossible unless the function of switching between stop and execution of writing is maintained.

In the audio signal processor 2, these functions are provided in the waveform transport I/O unit 211. Therefore, it is basically assumed that the above-described “abnormality” is an abnormality in a part other than the waveform transport I/O unit 211.

However, in the case where the waveform transport I/O unit 211 is configured such that even when some kind of abnormality has occurred in the waveform transport I/O unit 211 itself, the waveform transport I/O unit 211 can maintain the function of allowing received TL frames to flash therethrough as they are, the kind of abnormality in the waveform transport I/O unit 211 can be handled to be the above-described “abnormality”.

For example, that is the case where the waveform transport I/O unit 211 is configured such that a backup function is provided to allow the block through which signals relating to TL frames just flash to operate even when the power to other blocks is shut off, or a function of blocking writing is provided to prevent unnecessary data from being written into TL frames when an abnormality occurs in the data writing system, and so on.

2.3 Process to Control Switching between Active System and Standby System

Next, processes and operations executed by (the audio signal processors 2 serving as) the upstream mixer and the downstream mixer to realize the control of switching between the active system and the standby system as has been described above will be described.

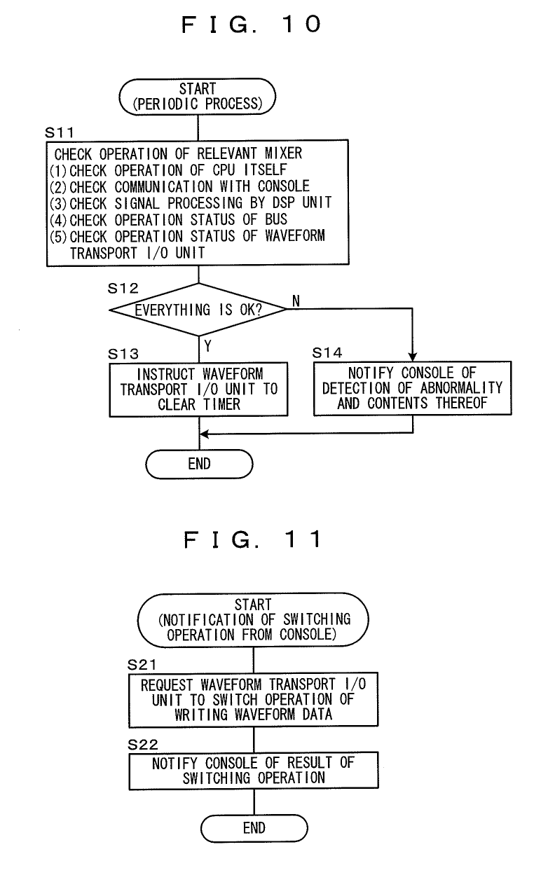

First, a flowchart of operation confirming process executed by the CPU of each of the mixers is shown in FIG. 10.

In the mixer system Z, the CPU 201 of the audio signal processor 2 serving as each of the upstream mixer B and the downstream mixer C periodically starts the process shown in FIG. 10.

The CPU 201 first checks operation of the relevant mixer in which the CPU is provided (S11), and when everything is OK (YES at S12), the CPU 201 instructs the waveform transport I/O unit 211 to clear the timer 43 (S13) and ends the process. If there is at least one item that is not OK (NO at S12) in the confirmation, the CPU 201 notifies the console Y of the detection of abnormality and contents thereof (S14) and ends the process.

By the above process, the timer 43 is periodically reset if there is no abnormality in operation of the mixer. Therefore, the waveform transport I/O unit 211 can judge that some kind of abnormality has occurred in operation of the mixer when the timer 43 counts up in a time period longer than the interval of the process in FIG. 10. The same judgment can be made even when the CPU 201 cannot perform the process in FIG. 10 itself because deadlock has occurred in some process by the CPU 201, or some process by the CPU 201 has entered an endless loop or the like.

Further, by setting the threshold value of counting by the timer 43 to a time period about a plurality of times the interval of the process in FIG. 10, a trigger for the operation according to the abnormality can be generated only after the time period during which the detection of abnormality in operation of the mixer continues for a predetermined time.

Note that conceivable items of operation to be checked at Step S11 include operation of the CPU 201 itself, communication with the console Y, status of execution of the signal processing at the DSP unit 212, statuses of operations of the audio bus 217 and the control bus 218, status of operation of the waveform transport I/O unit 211 and so on. However, when a failure of disabling reception and transmission of the TL frame has occurred in the waveform transport I/O unit 211, the configuration itself of the system shown in FIGS. 7A and 7B may not be maintained, and thus switching between the active system and the standby system may be impossible. However, it is preferable to notify the console Y of the fact that the abnormality has occurred even in that case, and therefore the above-described failure is included in the items to be confirmed at Step S11.

Further, the audio signal processor 2 can be incorporated in the audio network systems having various configurations, and therefore is not always a node which uses the function of switching the operation as described above. The audio signal processor 2 may operate as a node in a system having a single mixer.

Therefore, after the audio network system is formed, the CPU 201 in one of the nodes designates nodes as a pair of the active system and the standby system from among the nodes constituting the system according to instruction by the user or automatically, and causes the timer 43 to operate only for those nodes. Only for those nodes, the CPU 201 performs the above described detection of abnormality using the timer 43.

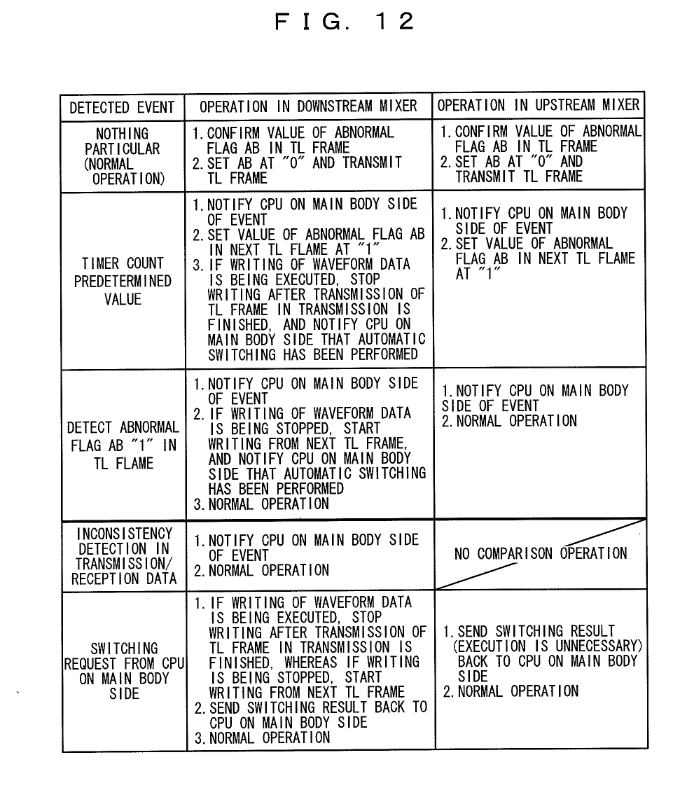

Next, a flowchart of process of switching write or not executed by the CPU of the mixer is shown in FIG. 11.

The console Y connected to the mixers accepts an instruction to switch between the active system and the standby system (switch between the state at (a) and the state (d) in FIG. 9) from the user through controls on the panel. Then, when the instruction is issued, the console Y generates a switching operation notification and transmits the notification to the upstream mixer B and the downstream mixer C to which the console Y is connected in order to instruct them to perform the switching.

Then, upon receiving the switching operation notification, the CPU 201 of each of the mixers starts the process shown in the flowchart in FIG. 11. Then, the CPU 201 firstly requests the waveform transport I/O unit 211 to switch the operation of writing the waveform data (S21). In response to the request, the waveform transport I/O unit 211 performs switching as described later and sends the result back to the CPU 201, and the CPU 201 notifies the console Y of the result (S22) and ends the process.

Next, operations relating to the function of switching between the active system and the standby system executed by the controller 41 of the waveform transport I/O unit 211 according to various events are shown in FIG. 12.

As shown in FIG. 12, the operations to be executed according to the same event are different depending on the waveform transport I/O units 211 provided in the upstream mixer B and the downstream mixer C. Then, the waveform transport I/O unit 211 judges whether the relevant mixer (audio signal processor) in which the unit itself is provided is located on the upstream side or on the downstream side from the network configuration information in the TL frame and information of the mixer forming a pair with the processor that is sent from the CPU 201, and performs the operation according to the judgment by the control of the controller 41.

Though the discrimination between the processes depending on whether the mixer is the active system or the standby system is not shown in FIG. 12, actually, there is an item where the controller 41 will perform a process different depending on whether the mixer is the active system or the standby system.

Further, the operation of setting the abnormality flag AB to “1” among the operations shown in FIG. 12 is preferably performed by the hardware process without instruction from the CPU when the timer count reaches a predetermined value.

Hereinafter, the operations shown in FIG. 12 will be described event by event.

First, the operation when there is no particular event is the same on the upstream side and the downstream side. More specifically, the waveform transport I/O unit 211 confirms the value of the abnormality flag AB written in the management data 102 of the received TL frame 100, and sets the abnormality flag AB at “0” indicating that there is no abnormality and transmits the TL frame to the next node. In addition to that, the waveform transport I/O unit 211 performs process of reading/writing waveform data and the like as necessary.

In contrast, when the count of the timer 43 reaches the predetermined value indicating an abnormality, this means that an abnormality disabling the mixer from operating as a mixer of the active system has occurred in the mixer.

Hence, the waveform transport I/O unit 211 first notifies the CPU 201 on the main body side of the audio signal processor 2 of occurrence of the event, that is, occurrence of abnormality in the mixer in both cases of the upstream side and the downstream side. Moreover, the waveform transport I/O unit 211 sets the abnormality flag AB at “1” in the TL frame to be transmitted next in order to transmit the occurrence of the abnormality to the mixer forming a pair with the relevant mixer.

In addition to the above operation, the waveform transport I/O unit 211 in the downstream mixer C stops the writing of waveform data if the writing is being executed, and also notifies the CPU 201 that the automatic switching of the writing operation has been performed. The writing being executed in the downstream mixer C is at the time when the downstream mixer C is used as the active system as shown at (a) in FIG. 9. The operation of detecting the timer count predetermined value event and stopping the writing in this state corresponds to the operation of shifting the state from (a) to (c) in FIG. 9.

Note that it is preferable to stop the writing of waveform data from the next TL frame after transmission of the TL frame in transmission at the occurrence of event is finished. This is because if the switching is performed in transmission of the frame, shift of the transmission timing or breakage of data may occur.

Further, the writing being not executed (being stopped) in the downstream mixer C is at the time when the downstream mixer C is used as the standby system as shown at (d) in FIG. 9. In this state, signal processing result in the downstream mixer C is not originally outputted to the external, and it is not necessary to change operation of the writing of waveform data according to the occurrence of abnormality.

Among the above-described operations, the operation of stopping the writing corresponds to the operation of switching between the active system and the standby system according to the switching instruction automatically generated by the timer. Further, the setting of the abnormality flag AB corresponds to the operation of transmitting the switching instruction to the mixer forming a pair with the relevant mixer.

An abnormality flag AB “1” detection event in the received TL frame in the next row occurs when the value of the abnormality flag AB is confirmed in the normal operation. The occurrence of this event means that the occurrence of abnormality is notified from the mixer forming a pair with the relevant mixer.

Hence, the waveform transport I/O unit 211 notifies the CPU 201 on the main body side of the audio signal processor 2 of occurrence of the event, that is, occurrence of abnormality in the mixer forming a pair with the mixer in which the unit is provided in both cases of the upstream side and the downstream side. Moreover, if the timer count predetermined value event has not occurred, the waveform transport I/O unit 211 sets the abnormality flag AB at “0” and transmits the TL frame in order to indicate that there is no abnormality in the mixer as part of the normal operation.

In addition to the above operation, the waveform transport I/O unit 211 starts the writing of waveform data in the downstream mixer C if the writing of waveform data is stopped, and also notifies the CPU 201 that the automatic switching of the writing mode has been performed. The writing being stopped in the downstream mixer C is at the time when the downstream mixer C is used as the standby system as shown at (d) in FIG. 9. The operation of detecting the abnormality in the mixer forming a pair with the relevant mixer and starting the writing in this state corresponds to the operation of shifting the state from (d) to (f) in FIG. 9.

For the same reason as that in the case of stopping the writing, it is preferable to start the writing of waveform data from the next TL frame after transmission of the TL frame in transmission at the occurrence of event is finished.

Further, the writing being not stopped (being executed) in the downstream mixer C is at the time when the downstream mixer C is used as the active system as shown at (a) in FIG. 9. In this state, occurrence of abnormality in the standby system from which signal processing result is not outputted to the external is notified, and therefore it is not necessary to change operation of the active system according to the notification.

Among the above-described operations, the operation of starting the writing corresponds to the operation of replacing the standby system with the active system according to the switching instruction received from the mixer forming a pair with the relevant mixer.

A transmission/reception data inconsistency detection event is an event which occurs when the waveform data comparing module 17 detects inconsistency between the waveform data which has been written into the TL frame by the upstream mixer B and the waveform data to be written into the TL frame by the downstream mixer C. This comparison is performed only in the downstream mixer C, and therefore the corresponding operation exists only in the downstream mixer C, and the waveform transport I/O unit 211 performs the operation of notifying the CPU 201 on the main body side of the occurred event.

Note that since which of the mixers has the abnormality cannot be judged only by the inconsistency, the waveform transport I/O unit 211 sets the value of the abnormality flag AB at “0” as in the case of normal operation.

Further, the switching request from the CPU on the main body side is a request which is transmitted by the process at Step S21 in FIG. 11 and also a request to switch between the state at (a) and the state at (d) in FIG. 9. Hence, in the downstream mixer C, the waveform transport I/O unit 211 stops the writing of waveform data if the writing is being executed, or starts the writing if the writing is being stopped, and sending the execution result back to the CPU 201. On the other hand, writing is performed in both cases and therefore the operation is not changed in the upstream mixer B. However, the waveform transport I/O unit 211 sends the response to the switching request back to the CPU 201.

Since the switching request does not indicate the abnormality in operation of the mixer, the waveform transport I/O unit 211 continues the normal operation even if the switching request has been issued, and sets the abnormality flag AB at “0” in both cases of the upstream side and the downstream side.

The waveform transport I/O unit 211 performs the above-described operation, whereby replacement of the active system with the standby system according to occurrence of abnormality in the audio signal processor 2 and replacement of the active system with the standby system according to operation by a user accepted by the console as has been described using FIG. 9 can be performed.

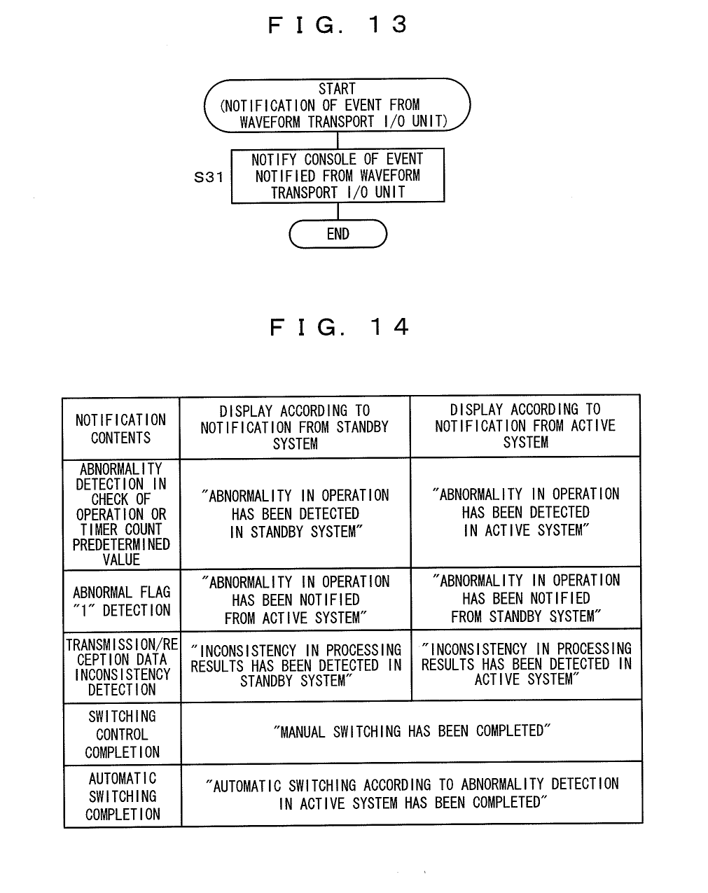

Note that notification of the events to the CPU 201 is performed to cause the console Y which is connected to the audio signal processor 2 to notify the user of contents of the switching and occurrence of the abnormality. Next, a flowchart of process, as the process for the notification of the events, executed by the CPU 201 when the CPU 201 receives the notification of an event from the waveform transport I/O unit 211 is shown in FIG. 13.

In the extent shown in FIG. 12, the events notified to the CPU 201 by the waveform transport I/O unit 211 are the timer count predetermined value event, the abnormality flag AB “1” detection event, the transmission/reception data inconsistency detection event, and the execution of automatic switching. Upon receiving one of those events, the CPU 201 starts the process shown in FIG. 13 and notifies the console Y connected to the audio signal processor 2 of the event notified from the waveform transport I/O unit 211 (S31) and ends the process.

Note that information to be notified to the console Y by the CPU 201 includes the abnormality detection at Step S14 in FIG. 10 and the switching operation result at Step S22 in FIG. 11 as well as the events notified in the process in FIG. 13.

Further, some abnormality has occurred in the mixer at occurrence of the timer count predetermined value event, and therefore the CPU 201 is not always capable of executing the process in FIG. 13.

Next, message examples to be displayed on the display device by the console Y according to the notifications are shown in FIG. 14.

Note that the console Y grasps whether each of the mixers to which the console Y is connected serves as the active system or the standby system. It is only required for the console Y to store the distinction between the mixers when enabling the function of switching between the active system and the standby system at the beginning and modify the contents every switching.

Upon receiving the notification from the mixer, the console Y displays on the display the notification contents and the corresponding message shown in FIG. 14 depending on whether the ID of the transmission source device is of the standby system or the active system.

First, upon receiving the notification of the abnormality detection or the notification of the timer count predetermined value, the console Y displays that an abnormality in operation has been detected in the mixer of the transmission source. Upon receiving the abnormality flag “1” detection, the console Y displays that an abnormality in operation has been detected in the mixer forming a pair with the mixer of the transmission source.

It is conceivable that when an abnormality in operation has occurred in the CPU 201 itself, the notification of the abnormality detection or the timer count predetermined value is not sent. However, as long as the waveform transport I/O unit 211 is operating, occurrence of abnormality is transmitted to the corresponding mixer (with which the relevant mixer is paired), and notified to the console Y from the corresponding mixer so that the console Y can display an appropriate message.

When the notification of the transmission/reception data inconsistency detection is sent, the console Y displays that inconsistency in the processing results of the waveform data between the active system and the standby system has been detected at the notification source. In this case, it cannot be instantly recognized that whether a failure occurs in the active system or the standby system. Therefore, some countermeasure may be automatically performed or left to the user.

When the notification of the switching operation completion is sent back at Step S22 in FIG. 11, the console Y displays that manual switching between the active system and the standby system has been completed. When the notification of the automatic switching execution is sent back, the console Y similarly displays that automatic switching has been completed.

Note that display of the automatic switching completion will be usually performed concurrently with or subsequently to the notification of occurrence of abnormality. However, it is conceivable that when the downstream mixer C performs automatic switching, the notification of the automatic switching completion cannot be sent to the console Y if an abnormality in operation occurs in the CPU 201. Therefore, it is preferable to transmit an appropriate command to the upstream mixer B to confirm the operation status of the downstream mixer C when the downstream mixer C is the active system and the notification of the automatic switching completion is not sent within a predetermined time period after the notification of occurrence of abnormality in the active system.

The console Y performs the above operation according to various kinds of information notified or relayed by the CPU 201, whereby operation statuses of the active system and the standby system in the audio network system can be appropriately notified to the user.

Incidentally, abnormalities possibly occurring in the audio network system include a break of wire connecting nodes as well as the failure in each node.

It is also conceivable that, in the audio network system descried above, when the nodes are connected in a loop in which two data transmission routes are formed among the nodes as shown in FIG. 1B and in FIG. 7B, the transmission routes can be automatically rearranged in response to the break of wire so that circulation of the TL frame can be continued even after the break of wire.

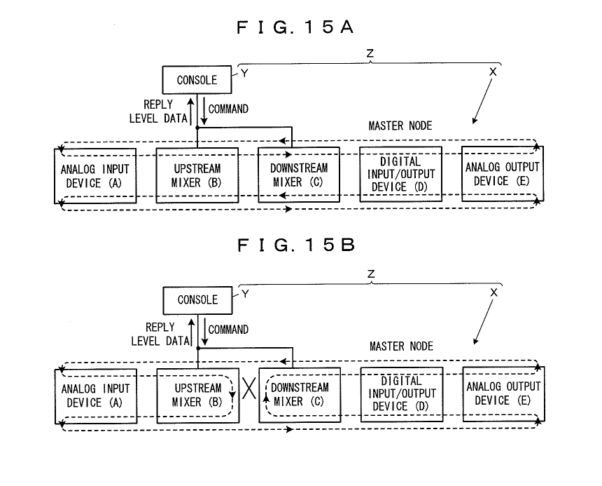

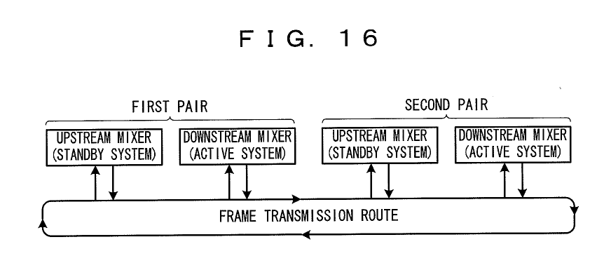

An example of this operation is shown in FIGS. 15A and 15B.

The audio network system shown in FIG. 15A is the same as that shown in FIG. 7B. In this system, there provided is a function of automatically rearranging, when a cable at some one location (the cable between the upstream mixer B and the downstream mixer C in this example) is broken in the system, the system into the system in a cascade connection with the wire break location positioned on both ends, by the nodes positioned on both sides of the wire break location switching the respective selectors on the side of the wire break location to the respective loopback line sides (see FIG. 6) to thereby loop back the transmission route.

In the case where such function is provided, if the audio network system transports audio signals using only one of the two transmission routes and using the other as a backup in the loop connection, the audio network system can continue the transport of waveform data of the same number of channels as that in the loop connection even if a break of wire occurs and the system is rearranged into the system in the cascade connection. Therefore, redundancy is given to the system so that the system can be made insusceptible to a failure.

In this case, if the system is configured such that audio signals are read from/written into the TL frame 100 when the TL frame 100 flashes through each node rightward in the drawing, for example, both in the state of the loop connection and the state of the cascade connection, frame processing order in the transmission route can be maintained even if order of nodes through which the TL frame 100 flashes is changed between before and after the rearrangement of the system due to a break of wire.

Therefore, a state in which control of switching between the active system and the standby system as has been described is possible can be maintained even when a break of wire and the rearrangement of the system in response to the break as shown in FIGS. 15A and 15B are performed.

However, when a break of wire occurs, a failure will temporarily occur in transport of the TL frame in the system for about one to several sampling periods. It is conceivable that such a failure in transport can be detected as an abnormality at step S11 in FIG. 10.

However, this abnormality is temporary and is to be immediately restored, and therefore it is unnecessary to switch between the standby system and the active system taking this abnormality as a trigger. Hence, in consideration of this, it is preferable to determine the “predetermined value” to prevent the timer count predetermined value event in FIG. 12 from occurring due to the abnormality in a short time to such an extent that occurs in the case of the rearrangement of the system.

### 3. Modifications

The explanation of the embodiments comes to an end, and it is of course that configuration of devices, configuration of data, concrete processing contents, and so on are not limited to those in the above-described embodiments.

Though examples in which the mixers of the active system and the standby system are provided one each is described in the above-described embodiments, the invention is not limited to those examples.

As shown in FIG. 16, it is also conceivable to provide a plurality of pairs of the active system and the standby system such that switching between the active system and the standby system can be performed independently in each pair. However, the mixer of the active system and the mixer of the standby system in the same pair need to be nodes adjacent to each other in the audio network system. Further, the abnormality flag is prepared for each pair. One console may be prepared for each pair, but one console may be used to operate a plurality of pairs of mixers.

Further, the signal processing engines prepared for the active system and the standby system are not limited to mixers. The invention is also applicable to, for example, the effector.

Though the console is configured to be independent of the signal processing engines in the above-described embodiments, any of the signal processing engines may be configured to be integral with the console.

Further, if the system is configured to have two consoles, it is preferable that one of the consoles operates as the master and the other operates as the slave irrespective of whether the signal processing engine is integral with the consoles or not. In this case, if abnormality occurs in the console operating as the master, the console operating as the slave is promoted to be the master to continue the operation, whereby the consoles can be made duplex.

Further, the two signal processing engines used as the active system and the standby system have the same hardware configuration in the above-described embodiments, which is not essential. For example, when the system is designed such that the signal processing engines at upper and lower grades have some extent of compatibility with each other, the signal processing engine at the upper grade can perform the same process as that in the signal processing engine at the lower grade. Accordingly, by setting the standby system at the grade higher than the active system in the above case, the standby system can make the same output as that by the active system when a failure occurs in the active system as in the above described embodiments even when the standby system and the active system have different hardware configurations.

Furthermore, though each signal processing engine judges by itself whether it is located on the upstream side or the downstream side in the above-described embodiments, the console may notify each signal processing engine of the position of the signal processing engine.

Further, transport method of the TL frame in the audio network system is not limited to the above-described method.

For example, it is not essential to circulate one TL frame in one sampling period, but it is also conceivable to circulate a plurality of TL frames in one sampling period, or to circulate one TL frame in a plurality of sampling periods (constant time length) into which, for each channel, plural samples of waveform data corresponding to the plurality of sampling periods are written.

Further, ratio of regions for waveform data and control data in a configuration of the TL frame may be certainly modified. Size of one of the regions may be 0. Moreover, the TL frame is not limited to the IEEE 802.3 format but may be in any format.

Although the sampling frequency is 96 kHz in the above-described embodiments, the system can be designed with any frequency such as 88.2 kHz, 192 kHz, or the like. The system may be designed such that the sampling frequency can be switched.

These modifications and modifications described in the explanation of the embodiments are applicable in any combination in a range without contradiction. Inversely, it is not always necessary for the network system and the audio signal processor to have all of the features which have been described in the explanation of the embodiments.

As is clear from the above description, according to the audio signal processing system of the invention, in an audio signal processing system transporting audio signals among a plurality of processors and performing signal processing, a function of continuing signal processing as before even when abnormality occurs in part of processors can be easily realized. Further, even if the signal processing engine which takes charge of writing the audio signals into the TL frame is changed to another, the another signal processing engine writes the audio signals into the same storage region as the previous engine did. Therefore, other processors reading the written audio signals do not need to change their operations according to the replacement but only need to continue the same operations as before.

Consequently, the fault-tolerant performance of the audio signal processing system can be enhanced by applying the present invention.

What is claimed is:

1. An audio signal processing system wherein a plurality of devices respectively comprising two sets of receivers and transmitters each performing communication in a single direction are connected in series by connecting one set of said receiver and transmitter in one device to one set of said transmitter and receiver in a next device by communication cables, respectively, an audio transport frame including a plurality of storage regions for audio signals circulates along a ring transmission route formed among said plurality of devices at a constant period, and each of said devices writes audio signals to the audio transport frame and/or reads audio signals from the audio transport frame, to thereby transport the audio signals among said plurality of devices,
a device among said plurality of devices is a first signal processing engine that reads audio signals from a first storage region of the audio transport frame, performs signal processing on the read audio signals according to control signals received from a console, and writes the processed audio signals into a second storage region of the audio transport frame,
another device among said plurality of devices is a second signal processing engine that corresponds to said first signal processing engine, reads audio signals from the first storage region of the audio transport frame, and performs signal processing on the read audio signals according to control signals received from the console, the signal processing being the same as that said corresponding first signal processing engine performs,
said first signal processing engine and said second signal processing engine are placed at two consecutive positions in the ring transmission route,
a device among said plurality of devices is an input device that writes audio signals inputted from an external of the audio signal processing system into the audio transport frame,
a device among said plurality of devices is an output device that is integrated with or separated from said input device, reads audio signals from the audio transport frame, and outputs the read audio signal to an external of the audio signal processing system, and
in response to a switching instruction, said first signal processing engine and/or second signal processing engine switches its operation such that the audio signal processed in said second signal processing engine is written into the second storage region of the audio transport frame and reaches said output device, while the audio signal processed in said first signal processing engine is written into the second storage region of the audio transport frame and reaches said output device before the switching.

2. An audio signal processing system comprising: a network system wherein a plurality of devices respectively comprising two sets of receivers and transmitters each performing communication in a single direction are connected in series by connecting one set of said receiver and transmitter in one device to one set of said transmitter and receiver in a next device by communication cables, respectively; and a console that is connected to a device among said plurality of devices and generates control signals to control devices constituting said network system,
wherein said network system circulates an audio transport frame including a plurality of storage regions for audio signals along a ring transmission route formed among said plurality of devices at a constant period, each of said devices writes audio signals to the audio transport frame and/or reads audio signals from the audio transport frame, to thereby transport the audio signals among said plurality of devices, and said network system is capable of transporting the control signals generated by the console to a target device among said plurality of devices,
a device among said plurality of devices is a first signal processing engine that reads audio signals from a first storage region of the audio transport frame, performs signal processing on the read audio signals according to the control signals, and writes the processed audio signals into a second storage region of the audio transport frame,
another device among said plurality of devices is a second signal processing engine that corresponds to said first signal processing engine, reads audio signals from the first storage region of the audio transport frame, performs signal processing on the read audio signals according to the control signals, the signal processing being the same as that said corresponding first signal processing engine performs, and writes the processed audio signals into the second storage region of the audio transport frame,
said second signal processing engine is placed at a position just before said first signal processing engine in the ring transmission route,
a device among said plurality of devices is an input device that writes audio signals inputted from an external of the audio signal processing system into the audio transport frame,
a device among said plurality of devices is an output device that is integrated with or separated from said input device, reads audio signals from the audio transport frame, and outputs the read audio signal to an external of the audio signal processing system, and
in response to a switching instruction, said first signal processing engine stops writing audio data into the second storage region of the audio transport frame from a next audio transport frame after transmission of an audio transport frame in transmission at detection of the switching instruction is finished.

3. An audio signal processing system wherein a plurality of devices respectively comprising two sets of receivers and transmitters each performing communication in a single direction are connected in series by connecting one set of said receiver and transmitter in one device to one set of said transmitter and receiver in a next device by communication cables, respectively, an audio transport frame including a plurality of storage regions for audio signals circulates along a ring transmission route formed among said plurality of devices at a constant period, and each of said devices writes audio signals to the audio transport frame and/or reads audio signals from the audio transport frame, to thereby transport the audio signals among said plurality of devices,
a device among said plurality of devices is a first signal processing engine that reads audio signals from a first storage region of the audio transport frame, performs signal processing on the read audio signals according to control signals received from a console, and writes the processed audio signals into a second storage region of the audio transport frame,
another device among said plurality of devices is a second signal processing engine that corresponds to said first signal processing engine, reads audio signals from the first storage region of the audio transport frame, and performs signal processing on the read audio signals according to control signals received from the console, the signal processing being the same as that said corresponding first signal processing engine performs,
said second signal processing engine in placed at a position just after said first signal processing engine in the ring transmission route,
a device among said plurality of devices is an input device that writes audio signals inputted from an external of the audio signal processing system into the audio transport frame,
a device among said plurality of devices is an output device that is integrated with or separated from said input device, reads audio signals from the audio transport frame, and outputs the read audio signal to an external of the audio signal processing system, and
in response to a switching instruction, said second signal processing engine starts writing the processed audio data into the second storage region of the audio transport frame from a next audio transport frame after transmission of an audio transport frame in transmission at detection of the switching instruction is finished.

4. The audio signal processing system according to claim 1, wherein said first signal processing engine comprises: a CPU that controls operation of said first signal processing engine; and a timer,
said CPU periodically resets said timer, and
said timer automatically generates said switching instruction if said timer has not been cleared for a period.

5. The audio signal processing system according to claim 2, wherein said first signal processing engine comprises: a CPU that controls operation of said first signal processing engine; and a timer,
said CPU periodically resets said timer, and
said timer automatically generates said switching instruction if said timer has not been cleared for a period.

6. The audio signal processing system according to claim 3, wherein said first signal processing engine comprises: a CPU that controls operation of said first signal processing engine; and a timer,
said CPU periodically resets said timer, and
said timer automatically generates said switching instruction if said timer has not been cleared for a period.

7. The audio signal processing system according to claim 1, wherein said console generates said switching instruction in response to an operation by a user, and sends the generated switching instruction to at least an audio signal processing engine which is disposed downstream of another in the transmission route among said first audio signal processing engine and said corresponding second signal processing engine.

8. The audio signal processing system according to claim 2, wherein said console generates said switching instruction in response to an operation by a user, and sends the generated switching instruction to at least an audio signal processing engine which is disposed downstream of another in the transmission route among said first audio signal processing engine and said corresponding second signal processing engine.

9. The audio signal processing system according to claim 3, wherein said console generates said switching instruction in response to an operation by a user, and sends the generated switching instruction to at least an audio signal processing engine which is disposed downstream of another in the transmission route among said first audio signal processing engine and said corresponding second signal processing engine.

10. The audio signal processing system according to claim 1, wherein said first signal processing engine comprises: a checker that checks operation of said first audio signal processing engine; and a notifier that, when said checker detects abnormality in the operation of said first audio signal processing engine, notifies said console of the detection of the abnormality.

11. The audio signal processing system according to claim 2, wherein said first signal processing engine comprises: a checker that checks operation of said first audio signal processing engine; and a notifier that, when said checker detects abnormality in the operation of said first audio signal processing engine, notifies said console of the detection of the abnormality.

12. The audio signal processing system according to claim 3, wherein said first signal processing engine comprises: a checker that checks operation of said first audio signal processing engine; and a notifier that, when said checker detects abnormality in the operation of said first audio signal processing engine, notifies said console of the detection of the abnormality.

13. The audio signal processing system according to claim 10, wherein said first signal processing engine further comprises a generator that automatically generates said switching instruction when said checker continues to detect the abnormality for a period.

14. The audio signal processing system according to claim 11, wherein said first signal processing engine further comprises a generator that automatically generates said switching instruction when said checker continues to detect the abnormality for a period.

15. The audio signal processing system according to claim 12, wherein said first signal processing engine further comprises a generator that automatically generates said switching instruction when said checker continues to detect the abnormality for a period.

16. The audio signal processing system according to claim 1, wherein an upstream engine which is disposed upstream of another down stream engine in the transmission route among said first audio signal processing engine and said corresponding second signal processing engine writes the audio signals having processed in the upstream engine into the second storage region of the audio transport frame, and
the downstream engine reads the audio signals written by said upstream engine from the second storage region of the audio transport frame, and compares the read audio signals with the audio signals having processed in the downstream engine, whereby searching inconsistency between the signal processing performed in the upstream engine and that in the downstream engine.

17. The audio signal processing system according to claim 2, wherein an upstream engine which is disposed upstream of another down stream engine in the transmission route among said first audio signal processing engine and said corresponding second signal processing engine writes the audio signals having processed in the upstream engine into the second storage region of the audio transport frame, and
the downstream engine reads the audio signals written by said upstream engine from the second storage region of the audio transport frame, and compares the read audio signals with the audio signals having processed in the downstream engine, whereby searching inconsistency between the signal processing performed in the upstream engine and that in the downstream engine.

18. The audio signal processing system according to claim 3, wherein an upstream engine which is disposed upstream of another down stream engine in the transmission route among said first audio signal processing engine and said corresponding second signal processing engine writes the audio signals having processed in the upstream engine into the second storage region of the audio transport frame, and
the downstream engine reads the audio signals written by said upstream engine from the second storage region of the audio transport frame, and compares the read audio signals with the audio signals having processed in the downstream engine, whereby searching inconsistency between the signal processing performed in the upstream engine and that in the downstream engine.
